(19) United States
(12) Patent Application Publication
(10) Pub. No.: US 2025/0386233 A1
(43) Pub. Date: Dec. 18, 2025

(54) SENSING METHOD AND APPARATUS

(71) Applicant: HUAWEI TECHNOLOGIES CO., LTD., Shenzhen (CN)

(72) Inventors: Rui DU, Singapore (SG); Gerile NAREN, Shenzhen (CN); Mengshi HU, Shenzhen (CN); Zhuqing TANG, Shenzhen (CN); Xiao HAN, Shenzhen (CN)

(21) Appl. No.: 19/314,122

(22) Filed: Aug. 29, 2025

Related U.S. Application Data
(63) Continuation of application No. PCT/CN2024/078806, filed on Feb. 27, 2024.

(30) Foreign Application Priority Data
Mar. 1, 2023 (CN) 202310243382.X

(51) Int. Cl. H04W 24/10; H04W 76/18

(52) U.S. Cl. CPC H04W 24/10; H04W 76/18

(57) ABSTRACT

A sensing method and an apparatus are provided, and are applied to a wireless local area network system. In the method, a first apparatus receives a first request message used to request to set up a sensing measurement; and sends a first response message to a second apparatus, where the first apparatus rejects the first request message, and the first response message includes first indication information, indicating to resend a request message for setting up a sensing measurement or not to resend a request message for setting up a sensing measurement. In the method, the first indication information indicates the second apparatus whether to re-initiate a sensing measurement setup request, so that the second apparatus determines an intention of the first apparatus based on the first indication information.

### CROSS-REFERENCE TO RELATED APPLICATIONS

This application is a continuation of International Application No. PCT/CN2024/078806, filed on Feb. 27, 2024, which claims priority to Chinese Patent Application No. 202310243382.X, filed on Mar. 1, 2023. The disclosure of the aforementioned applications are hereby incorporated by reference in their entireties.

### TECHNICAL FIELD

This application relates to the field of communication technologies, and in particular, to a sensing method and an apparatus.

### BACKGROUND

In daily life, a signal sent by a wireless fidelity (wireless fidelity, Wi-Fi) device is generally received after being reflected, diffracted, and scattered by various obstacles. By analyzing a wireless signal such as channel state information (channel state information, CSI) affected by various obstacles, a surrounding environment may be inferred and sensed, and therefore a wireless local area network (wireless local area network, WLAN) sensing technology is derived.

In Institute of Electrical and Electronics Engineers (Institute of Electrical and Electronics Engineers, IEEE) 802.11 series standards, a physical device may use the WLAN sensing technology to sense a target object based on these standards. For example, a receiver may receive a plurality of signals from a transmitter in a period of time, and perform channel estimation on the plurality of signals to separately obtain CSI. The receiver may send the obtained CSI to the transmitter. The transmitter may process the CSI in this period of time to obtain a channel change in this period of time. Alternatively, the receiver may process the CSI in this period of time to obtain a channel change in this period of time. Through the channel change, the transmitter or the receiver may determine an environment in which a channel is located and obtain a sensing result.

In a current standard, for example, 802.11bf, a sensing measurement technology easily causes a waste of air interface resources.

### SUMMARY

This application provides a sensing method and an apparatus, to guide a behavior of a sensing initiator to re-initiate a sensing measurement setup request when a sensing responder rejects a sensing measurement setup request, thereby reducing a waste of air interface resources.

According to a first aspect, this application provides a sensing method. The method is applied to a first apparatus or a chip in the first apparatus, and the method includes: receiving a first request message from a second apparatus, where the first request message is used to request to set up a sensing measurement; and
sending a first response message to the second apparatus, where the first apparatus rejects the first request message, the first response message includes first indication information, and the first indication information indicates the second apparatus to resend a second request message for setting up a sensing measurement, or the first indication information indicates the second apparatus not to resend a second request message for setting up a sensing measurement.

According to the method provided in this application, when the first apparatus rejects the sensing measurement setup, the first indication information indicates the second apparatus whether to re-initiate a sensing measurement setup request, thereby implementing information exchange between a sensing responder and a sensing initiator. In this way, when the sensing measurement setup is rejected by the sensing responder, the sensing initiator may more clearly determine an intention of the sensing responder based on the first indication information, thereby ensuring an efficient subsequent sensing measurement setup, and avoiding repeatedly initiating a sensing measurement setup request a plurality of times in a case of rejection. This can reduce resources consumed for setting up a sensing measurement.

In an implementation, a sending time of the second request message is greater than or equal to a first time, and is less than or equal to a second time.

In an implementation, the first response message further includes at least one of second indication information and third indication information; and
the second indication information indicates the first time, and the third indication information indicates the second time.

In an implementation, the first request message further includes a first sensing measurement parameters element field, the first sensing measurement parameters element field includes at least one sensing measurement parameter, the second request message includes a second sensing measurement parameters element field, and the first response message further includes a status code; and if the status code indicates that a sensing measurement setup request is rejected, and the first indication information indicates the second apparatus to resend the second request message for setting up a sensing measurement, a sensing measurement parameter in the second sensing measurement parameters element field is determined based on the at least one sensing measurement parameter in the first sensing measurement parameters element field.

In an implementation, the second request message includes a second sensing measurement parameters element field, the first response message further includes a third sensing measurement parameters element field and a status code, and the third sensing measurement parameters element field includes at least one sensing measurement parameter; and if the status code indicates that a sensing measurement setup request is rejected and a suggested measurement parameter is provided, and the first indication information indicates the second apparatus to resend the second request message for setting up a sensing measurement, a sensing measurement parameter in the second sensing measurement parameters element field is determined based on the at least one sensing measurement parameter in the third sensing measurement parameters element field.

In an implementation, the first response message further includes the status code; and the status code indicates that the sensing measurement setup request is rejected, and a rejection cause is that resources for the first apparatus to set up a sensing measurement as a sensing responder are full; or the status code indicates that the sensing measurement setup request is rejected, and a rejection cause is that the first apparatus or a sensing link is interfered with.

According to the method, the status code indicates the cause of rejecting the sensing measurement setup, so that the sensing initiator can determine a status of the sensing responder by using the status code, thereby helping re-initiate the sensing measurement setup request, and ensuring an efficient subsequent sensing measurement setup.

In an implementation, the first apparatus is a sensing responder, and the second apparatus is a sensing initiator.

In an implementation, the first request message is a sensing measurement setup request frame in a sensing measurement setup process in wireless local area network sensing; or the first request message is a directional multi-gigabit sensing measurement setup request frame in a sensing measurement setup process in directional multi-gigabit sensing.

In an implementation, before receiving the first request message from the second apparatus, the method further includes: receiving a probe request message from the second apparatus, where the probe request message includes sensing capability information of the second apparatus.

In an implementation, the first request message further includes sensing capability information of the second apparatus.

In an implementation, the first response message further includes the third sensing measurement parameters element field and the status code; and if the status code indicates that the sensing measurement setup request is rejected and the suggested measurement parameter is provided, and the first indication information indicates the second apparatus to resend the second request message for setting up a sensing measurement, the sensing measurement parameter in the third sensing measurement parameters element field is determined based on the sensing capability information of the second apparatus.

According to a second aspect, this application provides a sensing method. The method is applied to a second apparatus or a chip in the second apparatus, and the method includes: sending a first request message to a first apparatus, where the first request message is used to request to set up a sensing measurement; and receiving a first response message from the first apparatus, where the first apparatus rejects the first request message, the first response message includes first indication information, and the first indication information indicates the second apparatus to resend a second request message for setting up a sensing measurement, or the first indication information indicates the second apparatus not to resend a second request message for setting up a sensing measurement.

In an implementation, a sending time of the second request message is greater than or equal to a first time, and is less than or equal to a second time.

In an implementation, the first response message further includes at least one of second indication information and third indication information; and
the second indication information indicates the first time, and the third indication information indicates the second time.

In an implementation, the first request message further includes a first sensing measurement parameters element field, the first sensing measurement parameters element field includes at least one sensing measurement parameter, the second request message includes a second sensing measurement parameters element field, and the first response message further includes a status code; and
if the status code indicates that a sensing measurement setup request is rejected, and the first indication information indicates the second apparatus to resend the second request message for setting up a sensing measurement, a sensing measurement parameter in the second sensing measurement parameters element field is determined based on the at least one sensing measurement parameter in the first sensing measurement parameters element field.

In an implementation, the second request message includes a second sensing measurement parameters element field, the first response message further includes a third sensing measurement parameters element field and a status code, and the third sensing measurement parameters element field includes at least one sensing measurement parameter; and
if the status code indicates that a sensing measurement setup request is rejected and a suggested measurement parameter is provided, and the first indication information indicates the second apparatus to resend the second request message for setting up a sensing measurement, a sensing measurement parameter in the second sensing measurement parameters element field is determined based on the at least one sensing measurement parameter in the third sensing measurement parameters element field.

In an implementation, the first response message further includes a status code; and if the status code indicates that a sensing measurement setup request is rejected and a suggested measurement parameter is provided, and the first indication information indicates the second apparatus not to resend the second request message for setting up a sensing measurement, a time for the second apparatus to re-initiate a sensing measurement setup is after a third time.

In an implementation, the first response message further includes the status code; and the status code indicates that the sensing measurement setup request is rejected, and a rejection cause is that resources for the first apparatus to set up a sensing measurement as a sensing responder are full; or the status code indicates that the sensing measurement setup request is rejected, and a rejection cause is that the first apparatus or a sensing link is interfered with.

In an implementation, the first apparatus is a sensing responder, and the second apparatus is a sensing initiator.

In an implementation, the first request message is a sensing measurement setup request frame in a sensing measurement setup process in wireless local area network sensing; or the first request message is a directional multi-gigabit sensing measurement setup request frame in a sensing measurement setup process in directional multi-gigabit sensing.

In an implementation, before sending the first request message to the first apparatus, the method further includes:
sending a probe request message to the first apparatus, where the probe request message includes sensing capability information of the second apparatus.

In an implementation, the first request message further includes sensing capability information of the second apparatus.

In an implementation, the first response message further includes the third sensing measurement parameters element field and the status code; and
if the status code indicates that the sensing measurement setup request is rejected and the suggested measurement parameter is provided, and the first indication information indicates the second apparatus to send the second request message for setting up a sensing measurement, the sensing measurement parameter in the third sensing measurement parameters element field is determined based on the sensing capability information of the second apparatus.

According to a third aspect, this application provides a sensing method. The method is applied to a first apparatus or a chip in the first apparatus, and the method includes: receiving a first sensing by proxy request message from a second apparatus, where the first sensing by proxy request message is used to request the first apparatus to set up a sensing by proxy measurement or perform a sensing by proxy measurement; and sending a first sensing by proxy response message to the second apparatus, where the first apparatus rejects the first sensing by proxy request message, the first sensing by proxy response message includes first information, and the first information indicates the second apparatus to resend a second sensing by proxy request message for requesting the first apparatus to set up a sensing by proxy measurement, or the first information indicates the second apparatus not to resend a second sensing by proxy request message for requesting the first apparatus to set up a sensing by proxy measurement.

According to the method provided in this application, when the first apparatus rejects the sensing by proxy measurement setup, the first indication information indicates the second apparatus whether to re-initiate a sensing by proxy measurement setup request, thereby implementing information exchange between an SBP responder and an SBP initiator. In this way, when the sensing by proxy measurement setup is rejected by the SBP responder, the SBP initiator may more clearly determine an intention of the sensing responder based on the first indication information, thereby ensuring an efficient subsequent sensing by proxy measurement setup, and avoiding repeatedly initiating a sensing by proxy measurement setup request a plurality of times in a case of rejection. This can reduce resources consumed for setting up a sensing by proxy measurement.

In an implementation, a sending time of the second sensing by proxy request message is greater than or equal to a first time, and is less than or equal to a second time.

In an implementation, the first sensing by proxy response message further includes at least one of second information and third information; and
the second information indicates the first time, and the third information indicates the second time.

In an implementation, the first sensing by proxy response message includes a number of sensing responders field, and the number of sensing responders field indicates a number of sensing responders.

In an implementation, the first sensing by proxy response message further includes a status code, and the first sensing by proxy response message further includes at least one of a sensing responder address field and a sensing responder identifier field; and
if the status code indicates that a sensing by proxy measurement setup request is rejected and a suggested measurement parameter is provided, a number of address subfields included in the sensing responder address field is equal to the number of sensing responders indicated by the number of sensing responders field, and/or a number of identifier subfields included in the sensing responder identifier field is equal to the number of sensing responders indicated by the number of sensing responders field.

According to a fourth aspect, this application provides a sensing method. The method is applied to a second apparatus or a chip in the second apparatus, and the method includes: sending a first sensing by proxy request message to a first apparatus, where the first sensing by proxy request message is used to request the first apparatus to set up a sensing by proxy measurement or perform a sensing by proxy measurement; and receiving a first sensing by proxy response message from the first apparatus, where the first apparatus rejects the first sensing by proxy request message, the first sensing by proxy response message includes first information, and the first information indicates the second apparatus to resend a second sensing by proxy request message for requesting the first apparatus to set up a sensing by proxy measurement, or the first information indicates the second apparatus not to resend a second sensing by proxy request message for requesting the first apparatus to set up a sensing by proxy measurement.

In an implementation, a sending time of the second sensing by proxy request message is greater than or equal to a first time, and is less than or equal to a second time.

In an implementation, the first sensing by proxy response message further includes at least one of second information and third information; and
the second information indicates the first time, and the third information indicates the second time.

In an implementation, the first sensing by proxy response message includes a number of sensing responders field, and the number of sensing responders field indicates a number of sensing responders.

In an implementation, the first sensing by proxy response message further includes a status code, and the first sensing by proxy response message further includes at least one of a sensing responder address field and a sensing responder identifier field; and
if the status code indicates that a sensing by proxy measurement setup request is rejected and a suggested measurement parameter is provided, a number of address subfields included in the sensing responder address field is equal to the number of sensing responders indicated by the number of sensing responders field, and/or a number of identifier subfields included in the sensing responder identifier field is equal to the number of sensing responders indicated by the number of sensing responders field.

According to a fifth aspect, this application provides a sensing method. The method is applied to a second apparatus or a chip in the second apparatus, and the method includes: sending sensing capability information of the second apparatus to a first apparatus; and receiving a sensing measurement setup response message from the first apparatus, where the sensing measurement setup response message includes a status code, the status code indicates that a sensing measurement setup request is rejected and a suggested measurement parameter is provided, and the suggested measurement parameter is determined based on the sensing capability information of the second apparatus.

According to the method provided in this application, before sending the sensing measurement setup request frame to the first apparatus, the second apparatus exchanges the sensing capability information of the second apparatus with the first apparatus. If the status code in the sensing measurement setup response frame sent by the first apparatus indicates that the sensing measurement setup request is rejected and the suggested measurement parameter is provided, because the first apparatus may know the sensing capability information of the second apparatus, the suggested sensing measurement parameter for the second apparatus carried in the sensing measurement setup response frame is more compliant with the sensing capability information of the second apparatus, thereby improving sensing measurement setup efficiency.

In an implementation, the sensing capability information of the second apparatus is carried in a first message; and
the first message is a sensing measurement setup request message used to request to set up a sensing measurement; or the first message is a probe request message used to request capability information of the first apparatus.

In an implementation, the method further includes: sending a first sensing measurement setup request message to the first apparatus, where the first sensing measurement setup request message is used to request to set up a sensing measurement.

According to a sixth aspect, this application provides a sensing method. The method is applied to a first apparatus or a chip in the first apparatus, and the method includes: receiving sensing capability information from a second apparatus; and sending a sensing measurement setup response message to the second apparatus, where the sensing measurement setup response message includes a status code, the status code indicates that a sensing measurement setup request is rejected and a suggested measurement parameter is provided, and the suggested measurement parameter is determined based on the sensing capability information of the second apparatus.

In an implementation, the sensing capability information of the second apparatus is carried in a first message; and the first message is a sensing measurement setup request message used to request to set up a sensing measurement; or the first message is a probe request message used to request capability information of the first apparatus.

In an implementation, the method further includes: receiving a first sensing measurement setup request message from the second apparatus, where the first sensing measurement setup request message is used to request to set up a sensing measurement.

According to a seventh aspect, this application provides a sensing method. The method is applied to a first apparatus or a chip in the first apparatus, and includes: sending a third request message to a second apparatus, where the third request message is used to request to set up a first sensing measurement, the third request message includes measurement request indication information, and the measurement request indication information indicates the second apparatus to set up a sensing measurement as a sensing initiator when the second apparatus cannot accept the first request message as a sensing responder; and receiving a third response message from the second apparatus, where the third response message indicates that the third request message is rejected.

According to the foregoing method, when the first apparatus initiates the sensing measurement setup, the third request message may carry the measurement request indication information, to indicate the second apparatus to initiate the sensing measurement setup as a sensing initiator when the second apparatus cannot accept the first request message or the sensing measurement setup as a sensing responder. In this way, when the second apparatus rejects the sensing measurement requested by the first apparatus, the second apparatus may initiate a symmetrical sensing measurement as a sensing initiator, to assist the first apparatus in completing the sensing measurement, thereby resolving a problem of how to implement a sensing measurement setup when resources of the sensing responder are full.

In an implementation, the third response message includes measurement confirmation indication information, and the measurement confirmation indication information indicates that the second apparatus is to initiate a sensing measurement setup as a sensing initiator, or the measurement confirmation indication information indicates that the second apparatus is not to initiate a sensing measurement setup as a sensing initiator.

In an implementation, the method further includes: receiving a fourth request message from the second apparatus, where the fourth request message is used to request to set up a second sensing measurement, the fourth request message includes measurement indication information, and the measurement indication information indicates that the second sensing measurement that the fourth request message requests to set up is associated with the first sensing measurement.

In an implementation, the third request message further includes a first measurement setup identifier, and the fourth request message further includes a second measurement setup identifier and the first measurement setup identifier.

According to an eighth aspect, this application provides a sensing method. The method is applied to a second apparatus or a chip in the second apparatus, and includes: receiving a third request message from a first apparatus, where the third request message is used to request to set up a first sensing measurement, the third request message includes measurement request indication information, and the measurement request indication information indicates the second apparatus to set up a sensing measurement as a sensing initiator when the second apparatus cannot accept the first request message as a sensing responder; and sending a third response message to the first apparatus, where the third response message indicates that the third request message is rejected.

In an implementation, the third response message includes measurement confirmation indication information, and the measurement confirmation indication information indicates that the second apparatus is to initiate a sensing measurement setup as a sensing initiator, or the measurement confirmation indication information indicates that the second apparatus is not to initiate a sensing measurement setup as a sensing initiator.

In an implementation, the method further includes: sending a fourth request message to the first apparatus, where the fourth request message is used to request to set up a second sensing measurement, the fourth request message includes measurement indication information, and the measurement indication information indicates that the second sensing measurement that the fourth request message requests to set up is associated with the first sensing measurement.

In an implementation, the third request message further includes a first measurement setup identifier, and the fourth request message further includes a second measurement setup identifier and the first measurement setup identifier.

According to a ninth aspect, this application provides a sensing method. The method is applied to a first apparatus or a chip in the first apparatus, and the method includes: sending a third request message to a second apparatus, where the third request message is used to request to set up a first sensing measurement; and
receiving a third response message from the second apparatus, where the third response message indicates that the third request message is rejected; and sending a measurement setup query message to the second apparatus, where the measurement setup query message is used to request the second apparatus to set up a sensing measurement.

According to the foregoing method, when the sensing measurement setup initiated by the first apparatus is rejected, the measurement setup query message may be separately sent, to indicate the second apparatus to initiate the sensing measurement setup as a sensing initiator when the second apparatus rejects the sensing measurement setup. In this way, when the second apparatus rejects the sensing measurement requested by the first apparatus, the second apparatus may initiate a symmetrical sensing measurement as a sensing initiator, to assist the first apparatus in completing the sensing measurement, thereby resolving a problem of how to implement a sensing measurement setup when resources of a sensing responder are full.

In an implementation, the third request message further includes a first measurement setup identifier, and the measurement setup query message includes at least one of the following: a measurement setup identifier field, where the measurement setup identifier field includes the first measurement setup identifier, and a fourth sensing measurement parameters element field, where the fourth sensing measurement parameters element field includes at least one sensing measurement parameter.

In an implementation, the method further includes: receiving a fourth request message from the second apparatus, where the fourth request message is used to request to set up a second sensing measurement, the fourth request message includes measurement indication information, and the measurement indication information indicates that the sensing measurement that the fourth request message requests to set up is associated with the first sensing measurement.

In an implementation, the fourth request message includes a fifth sensing measurement parameters element field, and a sensing measurement parameter in the fifth sensing measurement parameters element field is determined based on the at least one sensing measurement parameter included in the fourth sensing measurement parameters element field.

According to a tenth aspect, this application provides a sensing method. The method is applied to a second apparatus or a chip in the second apparatus, and the method includes: receiving a third request message from a first apparatus, where the third request message is used to request to set up a first sensing measurement; sending a third response message to the first apparatus, where the third response message indicates that the third request message is rejected; and receiving a measurement setup query message from the first apparatus, where the measurement setup query message is used to request the second apparatus to set up a sensing measurement.

In an implementation, the third request message further includes a first measurement setup identifier, and the measurement setup query message includes at least one of the following: a measurement setup identifier field, where the measurement setup identifier field includes the first measurement setup identifier, and a fourth sensing measurement parameters element field, where the fourth sensing measurement parameters element field includes at least one sensing measurement parameter.

In an implementation, the method further includes: sending a fourth request message to the first apparatus, where the fourth request message is used to request to set up a second sensing measurement, the fourth request message includes measurement indication information, and the measurement indication information indicates that the sensing measurement that the fourth request message requests to set up is associated with the first sensing measurement.

In an implementation, the fourth request message includes a fifth sensing measurement parameters element field, and a sensing measurement parameter in the fifth sensing measurement parameters element field is determined based on the at least one sensing measurement parameter included in the fourth sensing measurement parameters element field.

According to an eleventh aspect, a communication apparatus is provided. The communication apparatus may be the first apparatus or the second apparatus in the first aspect to the tenth aspect. The communication apparatus may include a communication unit and a processing unit, to perform any one of the first aspect to the tenth aspect or perform any one of the possible implementations of the first aspect to the tenth aspect. The communication unit is configured to perform functions related to sending and receiving. Optionally, the communication unit includes a receiving unit and a sending unit. In a design, the communication apparatus is a communication chip, the processing unit may be one or more processors or processor cores, and the communication unit may be an input/output circuit or a port of the communication chip.

In another design, the communication unit may be a transmitter and a receiver, or the communication unit may be a transmitter machine and a receiver machine.

Optionally, the communication apparatus further includes modules that may be configured to perform any one of the first aspect to the tenth aspect or perform any one of the possible implementations of the first aspect to the tenth aspect.

According to a twelfth aspect, a communication apparatus is provided. The communication apparatus may be the first apparatus or the second apparatus in the first aspect to the tenth aspect. The communication apparatus may include a processor and a memory, to perform any one of the first aspect to the tenth aspect or perform any one of the possible implementations of the first aspect to the tenth aspect. Optionally, the communication apparatus further includes a communication interface. The memory is configured to store a computer program or instructions. The processor is configured to invoke the computer program or the instructions from the memory and run the computer program or the instructions. When the processor executes the computer program or the instructions in the memory, the communication apparatus is enabled to perform any one of the first aspect to the tenth aspect or perform any one of the possible implementations of the first aspect to the tenth aspect.

Optionally, there are one or more processors, and there are one or more memories.

Optionally, the memory may be integrated with the processor, or the memory and the processor are disposed separately.

Optionally, the communication interface may include a transmitter (transmitter machine) and a receiver (receiver machine).

According to a thirteenth aspect, a communication apparatus is provided. The communication apparatus may be the foregoing first apparatus or the foregoing second apparatus. The communication apparatus may include a processor, to perform any one of the first aspect to the tenth aspect or perform any one of the possible implementations of the first aspect to the tenth aspect. The processor is coupled to a memory. Optionally, the communication apparatus further includes the memory. Optionally, the communication apparatus further includes a communication interface, and the processor is coupled to the communication interface.

In an implementation, when the communication apparatus is a first apparatus or a second apparatus, the communication interface may be a transceiver or an input/output interface. Optionally, the transceiver may be a transceiver circuit. Optionally, the input/output interface may be an input/output circuit.

In another implementation, when the communication apparatus is a chip or a chip system, the communication interface may be an input/output interface, an interface circuit, an output circuit, an input circuit, a pin, a related circuit, or the like on the chip or the chip system. The processor may alternatively be embodied as a processing circuit or a logic circuit.

According to a fourteenth aspect, a system is provided. The system includes the foregoing first apparatus and the foregoing second apparatus. The first apparatus may be configured to perform functions performed by the first apparatus in any one of the first aspect to the tenth aspect, and the second apparatus may be configured to perform functions performed by the second apparatus in any one of the first aspect to the tenth aspect.

According to a fifteenth aspect, a computer program product is provided. The computer program product includes a computer program (which may also be referred to as code or instructions). When the computer program is run, a computer is enabled to perform any one of the first aspect to the tenth aspect or perform any one of the possible implementations of the first aspect to the tenth aspect.

According to a sixteenth aspect, a computer-readable storage medium is provided. The computer-readable storage medium stores a computer program (which may also be referred to as code or instructions). When the computer program is run on a computer, the computer is enabled to perform any one of the first aspect to the tenth aspect or perform any one of the possible implementations of the first aspect to the tenth aspect.

According to a seventeenth aspect, a chip system is provided. The chip system may include a processor. The processor is coupled to a memory, and may be configured to perform any one of the first aspect to the tenth aspect or perform any one of the possible implementations of the first aspect to the tenth aspect. Optionally, the chip system further includes the memory. The memory is configured to store a computer program (which may also be referred to as code or instructions). The processor is configured to invoke the computer program from the memory and run the computer program, so that a device on which the chip system is installed performs any one of the first aspect to the tenth aspect or performs any one of the possible implementations of the first aspect to the tenth aspect.

According to an eighteenth aspect, a processing apparatus is provided, including an interface circuit and a processing circuit. The interface circuit may include an input circuit and an output circuit. The processing circuit is configured to: receive a signal through the input circuit, and transmit a signal through the output circuit, so that any one of the first aspect to the tenth aspect or any one of the possible implementations of the first aspect to the tenth aspect is implemented.

In a specific implementation process, the processing apparatus may be a chip, the input circuit may be an input pin, the output circuit may be an output pin, and the processing circuit may be a transistor, a gate circuit, a trigger, various logic circuits, or the like. An input signal received by the input circuit may be received and input by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the processor and various circuits are not limited in this application.

In an implementation, when the communication apparatus is a first apparatus or a second apparatus, the interface circuit may be a radio frequency processing chip in the first apparatus or the second apparatus, and the processing circuit may be a baseband processing chip in the first apparatus or the second apparatus.

In another implementation, the communication apparatus may be a part of component in the first apparatus or the second apparatus, for example, an integrated circuit product like a system chip or a communication chip. The interface circuit may be an input/output interface, an interface circuit, an output circuit, an input circuit, a pin, a related circuit, or the like on the chip or the chip system. The processing circuit may be a logic circuit on the chip.

### BRIEF DESCRIPTION OF DRAWINGS

FIG. 1 is a diagram of a network architecture of a WLAN to which an embodiment of this application is applicable;

FIG. 2 is a schematic flowchart of a sensing method according to an embodiment of this application;

FIG. 3 is a diagram of a structure of a sensing measurement setup response frame according to an embodiment of this application;

FIG. 4 is a schematic flowchart of a sensing method according to an embodiment of this application;

FIG. 5 is a diagram of a structure of an SBP response frame according to an embodiment of this application;

FIG. 6 is a diagram of a structure of an SBP parameters element field according to an embodiment of this application;

FIG. 7 is a schematic flowchart of a sensing method according to an embodiment of this application;

FIG. 8 is a diagram of a structure of a sensing measurement setup request frame according to an embodiment of this application;

FIG. 9 is a diagram of a structure of a sensing measurement setup request frame according to an embodiment of this application;

FIG. 10 is a schematic flowchart of a sensing method according to an embodiment of this application;

FIG. 11 is a diagram of a structure of a measurement setup query message according to an embodiment of this application;

FIG. 12 is a diagram of a structure of a measurement setup query message according to an embodiment of this application;

FIG. 13 is a diagram of a structure of a sensing measurement setup request frame according to an embodiment of this application;

FIG. 14 is a schematic flowchart of a sensing method according to an embodiment of this application;

FIG. 15 is a diagram of a structure of a communication apparatus according to an embodiment of this application; and

FIG. 16 is a diagram of a structure of a communication apparatus according to an embodiment of this application.

### DESCRIPTION OF EMBODIMENTS

The following describes in detail embodiments of this application with reference to the accompanying drawings of the specification.

Embodiments of this application are applicable to a WLAN scenario, for example, are applicable to Institute of Electrical and Electronics Engineers (Institute of Electrical and Electronics Engineers, IEEE) 802.11 system standards, for example, an 802.11ax standard, or a next generation thereof, for example, an 802.11be standard, Wi-Fi 7 or extremely high throughput (extremely high throughput, EHT), 802.11ad, 802.11ay, or 802.11bf. Alternatively, embodiments of this application are applicable to a wireless local area network system such as an internet of things (internet of things, IOT) network or a vehicle-to-everything (Vehicle to X, V2X) network. Certainly, embodiments of this application are further applicable to other possible communication systems, for example, a new radio (new radio, NR) system, a long term evolution (long term evolution, LTE) system, and a future 6G communication system.

The following uses an 802.11bf scenario as an example for description in embodiments of this application. Embodiments of this application relate to a sensing technology. The following describes related content of the sensing technology.

A sensing measurement may also be referred to as wireless sensing or WLAN sensing, and means that a transmitter and a receiver transmit a signal to discover a target or determine a target status. The WLAN sensing means that a station (station, STA) having a WLAN sensing capability uses a received WLAN signal to detect feature information of an expected target in a given environment. For example, the feature information includes one or more of a distance, a speed, an angle, a motion, existence or proximity, and a gesture. The target includes one or more of an object, a person, an animal, and the like. The environment includes one or more of a room, a house, a vehicle, an enterprise, and the like.

For example, the transmitter may send a signal used for a sensing measurement to the receiver, and the receiver may measure the signal to obtain a channel estimation result, for example, CSI. The receiver may perform sensing based on the CSI. Alternatively, the receiver may send the channel estimation result to the transmitter, and the transmitter performs target sensing or target status sensing based on the channel estimation result. For example, the receiver or the transmitter may process the CSI, to determine whether a moving object exists in the environment.

In a sensing measurement process, devices that participate in sensing are mainly as follows:

Sensing initiator (sensing initiator): a device that initiates a sensing measurement procedure and sends a sensing measurement setup request. For a non-DMG device, the sensing initiator is a device that sends a sensing measurement setup request frame. For a DMG device, the sensing initiator is a device that sends a DMG sensing measurement setup request frame.

Sensing responder (sensing responder): a device that responds to the sensing procedure initiated by the sensing initiator and sends a sensing measurement response. For a non-DMG device, the sensing responder is a device that sends a sensing measurement setup response frame. For a DMG device, the sensing responder is a device that sends a DMG sensing measurement setup response frame.

Sensing transmitter (sensing transmitter): a device that sends a sensing signal. The sensing signal may be a signal used for a sensing measurement, for example, a physical layer protocol data unit (physical layer protocol data unit, PPDU). Sensing may be WLAN sensing, or may be DMG sensing.

Sensing receiver (sensing receiver): a device that receives the sensing signal sent by the sensing transmitter. The sensing may be WLAN sensing, or may be DMG sensing.

The WLAN sensing usually includes the following several processes: a sensing session setup, a sensing measurement setup, a sensing measurement instance, sensing measurement disabling/termination, and sensing session disabling/termination.

After the sensing initiator completes a sensing measurement setup, the sensing initiator initiates one or more sensing measurement instances (sensing measurement instance). The sensing measurement instance may be classified into a trigger-based (trigger-based, TB) sensing measurement instance and a non-trigger-based (non-trigger-based, Non-TB) measurement instance. The TB sensing measurement instance is generally initiated by an AP, and the non-TB sensing measurement instance is generally initiated by a STA.

In an example of the TB sensing measurement instance, at least one of a polling phase (polling phase), a trigger frame (trigger frame, TF) sounding phase (sounding phase), a null data packet (data packet) announcement (null data packet announcement, NDPA) sounding phase (sounding phase), and a reporting phase (reporting phase) may be included.

In addition to the foregoing WLAN sensing procedure, 802.11bf also includes a sensing by proxy (proxy) procedure. The following describes an existing sensing by proxy (proxy) procedure.

A typical sensing by proxy (proxy) (sensing by proxy, SBP) procedure is initiated by a nonaccess point (non-access point, non-AP) (sending an SBP request) and responded to by an AP (receiving the SBP request and sending an SBP response).

In this scenario, a device that sends an SBP request (SBP Request) is referred to as an SBP initiator (SBP initiator), and the SBP initiator is generally a STA.

A device that receives an SBP request and sends an SBP response (SBP Response) is referred to an SBP responder (SBP responder), and the SBP responder is generally an AP.

After receiving the SBP request, the AP, as the SBP responder, performs a sensing setup based on a parameter carried in the SBP request. The foregoing WLAN sensing setup, measurement, and reporting procedures are reused subsequently.

In the SBP reporting phase, the AP, as the SBP responder, collects a result of a set-up sensing measurement and reports the result to the SBP initiator (STA).

In the SBP termination phase, the SBP initiator or SBP responder may terminate a set-up SBP procedure.

With reference to the accompanying drawings, the following explains and describes an information transmission method provided in embodiments of this application.

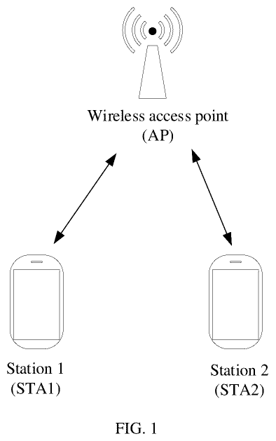

FIG. 1 is a diagram of a network architecture of a WLAN to which an embodiment of this application is applicable. In FIG. 1, an example in which the WLAN includes one wireless access point (access point, AP) and two stations (station, STA) is used. In addition, embodiments of this application are also applicable to communication between APs. For example, the APs may communicate with each other by using a distributed system (distributed system, DS). Embodiments of this application are also applicable to communication between STAs. It should be understood that quantities of APs and STAs in FIG. 1 are merely an example. There may be more or fewer APs and STAs.

A STA associated with the AP may be briefly referred to as an associated STA, and the STA may set up an association with the AP by using an association procedure. A STA that does not set up an association with the AP may be briefly referred to as a non-associated STA.

The access point may be an access point through which a terminal device (for example, a mobile phone) accesses a wired (or wireless) network, and is mainly deployed in a home, a building, and a campus, with a typical coverage radius ranging from dozens of meters to hundreds of meters. Certainly, the access point may alternatively be deployed outdoors. The access point is equivalent to a bridge that connects the wired network and the wireless network. The access point is mainly used to connect various wireless network clients together and then connect the wireless network to the Ethernet. Specifically, the access point may be a terminal device (such as a mobile phone) or a network device (such as a router) with a Wi-Fi chip. The access point may be a device that supports the 802.11be standard. Alternatively, the access point may be a device that supports a plurality of wireless local area networks (wireless local area network, WLAN) standards of the 802.11 family such as 802.11ay, 802.11ad, 802.11ax, 802.11ac, 802.11n, 802.11g, 802.11b, 802.11a, and a next-generation standard of 802.11be. The access point in this application may be an HE AP, an extremely high throughput (extremely high throughput, EHT) AP, or an access point applicable to a future-generation Wi-Fi standard.

The station may be a wireless communication chip, a wireless sensor, a wireless communication terminal, or the like, and may also be referred to as a user. For example, the station may be a mobile phone, a tablet computer, a set-top box, a smart television set, a smart wearable device, a vehicle-mounted communication device, or a computer that supports a Wi-Fi communication function. Optionally, the station may support the 802.11be standard. Alternatively, the station may support a plurality of wireless local area networks (wireless local area network, WLAN) standards of the 802.11 family such as 802.11ay, 802.11ad, 802.11ax, 802.11ac, 802.11n, 802.11g, 802.11b, 802.11a, and a next-generation standard of 802.11be.

The station in this application may be a directional multi-gigabit (directional multi-gigabit, DMG) STA, an EDMG enhanced directional multi-gigabit (enhanced directional multi-gigabit, EDMG) STA, an HE STA, or an extremely high throughput (extremely high throughput, EHT) STA, or may be a STA applicable to a future-generation Wi-Fi standard.

For example, the access point and the station may be devices used in the internet of vehicles, internet of things nodes or sensors in the internet of things (IoT, internet of things), smart cameras, smart remote controls, or smart water or electricity meters in the smart home, or sensors in the smart city.

The AP and the STA in embodiments of this application may be an AP and a STA that

are applicable to the IEEE 802.11 system standard. The AP is an apparatus that is deployed in a wireless communication network and that provides a wireless communication function for a STA associated with the AP. The AP may be used as a center of the communication system, and is usually a network-side product that supports MAC and PHY in the 802.11 system standard, for example, may be a communication device such as a base station, a router, a gateway, a repeater, a communication server, a switch, or a bridge. The base station may include a macro base station, a micro base station, a relay station, or the like in various forms. Herein, for ease of description, the devices mentioned above are collectively referred to as an AP. The STA is usually a terminal product that supports medium access control (medium access control, MAC) and physical layer (physical, PHY) in the 802.11 system standard, for example, a mobile phone or a notebook computer.

Currently, if a device has completed a sensing session setup, and needs to initiate a sensing measurement setup, the device needs to send a sensing measurement setup request frame. After receiving the sensing measurement setup request frame, a sensing responder replies with a sensing measurement setup response frame. The sensing responder rejects a sensing measurement setup request by using the sensing measurement setup response frame, but does not guide a behavior of the sensing measurement responder to re-initiate a sensing measurement request. If the sensing initiator cannot obtain further information, the sensing initiator may attempt to initiate a sensing measurement setup request a plurality of times, which causes occupation and a waste of air interface resources. Therefore, this application provides a method, to guide a behavior of a sensing initiator to re-initiate a sensing measurement setup request when a sensing responder rejects a sensing measurement setup, so that the sensing initiator does not re-initiate a sensing request a plurality of times, thereby reducing a waste of air interface resources.

This application is applicable to a plurality of sensing measurement setup processes, including but not limited to a sensing measurement setup process in WLAN sensing and a DMG sensing measurement setup process in DMG sensing. The wireless local area network sensing, that is, the WLAN sensing, may also be referred to as a name such as non-DMG sensing (Non-DMG Sensing), sensing (Sensing), or sub-7 GHz sensing (Sub-7 GHz Sensing), and for ease of description, is referred to as wireless local area network sensing below. The DMG sensing may also be referred to as a name such as 60 GHz sensing (60 GHz Sensing) or millimeter wave sensing (Millimeter Wave Sensing, MMW Sensing), and for ease of description, is referred to as DMG sensing below.

A network architecture and a service scenario described in embodiments of this application are intended to describe the technical solutions in embodiments of this application more clearly, and do not constitute a limitation on the technical solutions provided in embodiments of this application. A person of ordinary skill in the art may learn that, with evolution of the network architecture and emergence of new service scenarios, the technical solutions provided in embodiments of this application are also applicable to similar technical problems.

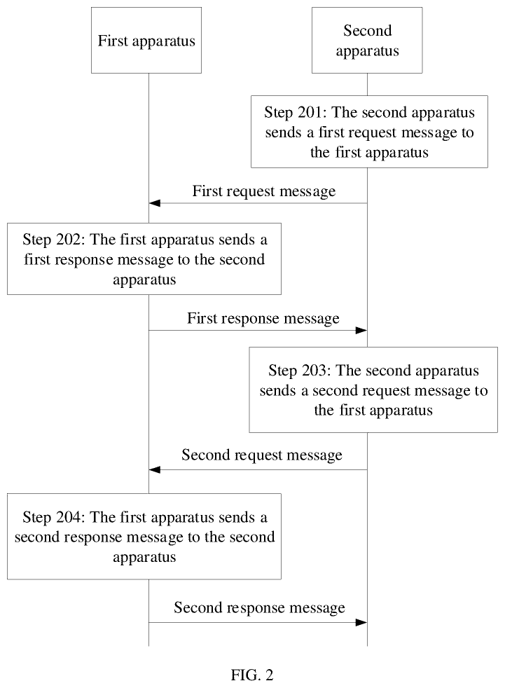

FIG. 2 is a schematic flowchart of a sensing method according to an embodiment of this application. When the method procedure provided in this embodiment of this application is applied to the system shown in FIG. 1, the AP or the chip in the AP or the STA or the chip in the STA in FIG. 1 may perform a method performed by a first apparatus in the following procedure, and the AP or the chip in the AP or the STA or the chip in the STA in FIG. 1 may perform a method performed by a second apparatus in the following procedure. It may be understood that a specific structure of an execution body of the method provided in this embodiment of this application is not specifically limited in the following embodiments, provided that a program that records code for the method provided in this embodiment of this application can be run to perform communication according to the method provided in this embodiment of this application. The method includes the following steps.

Step 201: The second apparatus sends a first request message to the first apparatus.

Correspondingly, the first apparatus receives the first request message from the second apparatus.

In an implementation, in the procedure in FIG. 2, the second apparatus may be a sensing initiator, and the first apparatus may be a sensing responder.

In an implementation, the first request message is used to request to set up a sensing measurement, that is, the first request message is a message used to request to set up a sensing measurement. For example, the first request message may be a sensing measurement setup request (sensing measurement setup request) frame in a sensing measurement setup process in wireless local area network sensing or a DMG sensing measurement setup request frame in a sensing measurement setup process in DMG sensing, the sensing measurement setup request frame or the DMG sensing measurement setup request frame may indicate a role (a sensing transmitter or a sensing receiver) of the sensing responder in the sensing measurement and a related sensing measurement parameter. In this application, unless otherwise specified, the sensing measurement setup request frame may be a request frame in the sensing measurement setup process in wireless local area network sensing, and the DMG sensing measurement setup request frame may be a request frame in the sensing measurement setup process in DMG sensing.

Step 202: The first apparatus sends a first response message to the second apparatus.

Correspondingly, the second apparatus receives the first response message from the first apparatus.

The first response message is a message in response to the first request message. For example, the first response message may be a sensing measurement setup response (sensing measurement setup response) frame or a DMG sensing measurement setup response frame. In this application, unless otherwise specified, the sensing measurement setup response frame may be a response frame in the sensing measurement setup process in wireless local area network sensing, and the DMG sensing measurement setup response frame may be a response frame in the sensing measurement setup process in DMG sensing.

In an implementation, the first apparatus rejects the first request message, that is, the first apparatus rejects the sensing measurement setup requested by the second apparatus, and the first response message may include first indication information. The first indication information indicates the second apparatus to resend a request message (for example, a second request message) for setting up a sensing measurement, or the first indication information indicates the second apparatus not to resend a request message for setting up a sensing measurement.

That the first indication information indicates the second apparatus to resend the request message for setting up a sensing measurement may be replaced with a description having a same meaning as “the first indication information indicates the second apparatus to re-initiate a sensing measurement setup”. That the first indication information indicates the second apparatus not to resend the request message for setting up a sensing measurement may be replaced with a description having a same meaning as “the first indication information indicates the second apparatus not to re-initiate a sensing measurement setup”. This is not limited in this application.

In an implementation, when the first indication information indicates the second apparatus to resend the second request message for setting up a sensing measurement, a sending time of the second request message is greater than or equal to a first time, and is less than or equal to a second time, where the first time and the second time are preset, or may be indicated by the first apparatus. The second time is after the first time.

In an implementation, the first response message further includes at least one of second indication information and third indication information; and
the second indication information indicates the first time, and the third indication information indicates the second time.

In an implementation, the first response message may include a sensing comeback information field. The sensing comeback information field may include a comeback (comeback) subfield, an initiator/STA comeback after exponent (Initiator/STA Comeback After Exponent) subfield, and an initiator/STA comeback after exponent (Initiator/STA Comeback Before Exponent) subfield. The comeback subfield is used to carry the first indication information, the initiator/STA comeback after exponent subfield is used to carry the second indication information, and the initiator/STA comeback before exponent subfield is used to carry the third indication information. The sensing comeback information field may further include another subfield, for example, a reserved (reserved) subfield.

Names of the foregoing fields and subfields are merely examples, and may have other names. This is not limited in this application. For example, the initiator/STA comeback after exponent may also be referred to as comeback after exponent, and the initiator/STA comeback before exponent may also be referred to as comeback before exponent.

For example, the sensing comeback information field may not be shown in Table 1.

TABLE 1

| Subfield name | Indicated content |
|---|---|
| Comeback | First indication information: The second apparatus resends the |
| | request message for setting up a sensing measurement, or the |
| | second apparatus does not resend the request message for setting |
| | up a sensing measurement. |
| Initiator/STA | Second indication information: The first time may be defined as, |
| comeback | for example, 2^{(Comeback After Exponent+4)} ms (a value range is greater |
| after exponent | than or equal to 16 ms and less than or equal to 2048 ms), or the |
| | first time is indicated in another manner, provided that the first |
| | time can represent one time. |
| Initiator/STA | Third indication information: The second time may be defined as, |
| comeback | for example, 2^{(Comeback Before Exponent+12)} ms (a value range is greater |
| before exponent | than or equal to 4096 ms and less than or equal to 65536 ms), or |
| | the second time is indicated in another manner, provided that the |
| | second time can represent one time. |
| Reserved | Reserved field |

In an implementation, a start time and an end time of a first time period are times relative to a preset time reference point. For example, if the second indication information indicates 2048 ms, and the third indication information indicates 4096 ms, the first time is a time at an interval of 2048 ms from the preset time reference point, and the second time is a time at an interval of 4096 ms from the preset time reference point. For example, if the preset time reference point is Tref, the first time is Tref+2048 ms, and the second time is Tref+4096 ms.

For example, the preset time reference point may be any one of the following:
a start moment or an end moment at which the second apparatus receives the first response message;
a start moment or an end moment at which the first apparatus sends the first response message;
a start moment or an end moment at which the second apparatus sends the first request message; or
a start moment or an end moment at which the first apparatus receives the first request message.

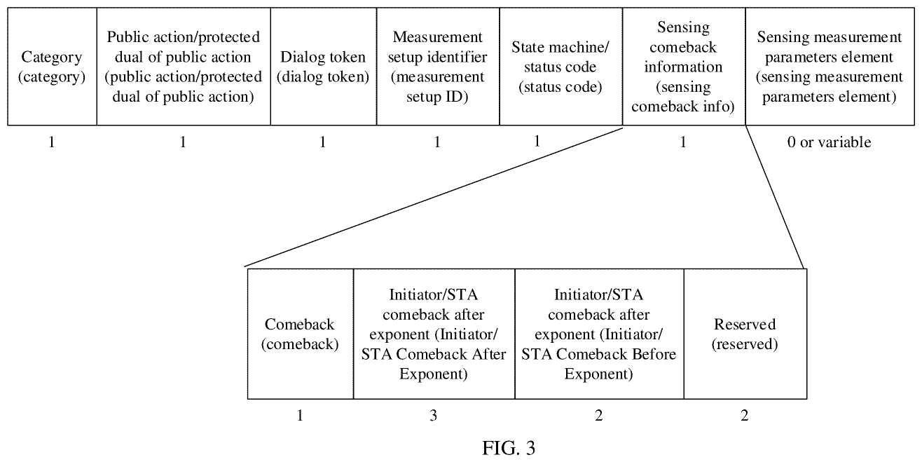

In an implementation, when the first response message is the sensing measurement setup response frame, the first response message may be shown in FIG. 3. FIG. 3 is an example diagram of a structure of a sensing measurement setup response frame according to an embodiment of this application. The sensing measurement setup response frame may include one or more of the following fields: a category (category), a public action/protected dual of public action (public action/protected dual of public action), a dialog token (dialog token), a measurement setup identifier (identifier, ID) (measurement setup ID), a state machine/status code (status code), sensing comeback information (sensing comeback info), and a sensing measurement parameters element (sensing measurement parameters element).

A structure of an action field (action field) of the sensing measurement setup response frame is merely an example. The sensing comeback information field may be located after the state machine/status code field, or may be located before the state machine/status code field, or may be located at any location of the action field (action field) of the sensing measurement setup response frame, as shown in the example in the figure. This is not specifically limited in this application.

The category field may indicate a category of a message; the public action/protected dual of public action may indicate an action of the message; and the dialog token may identify a dialog, for example, a pair of request (request) and response (response) that correspond to each other may have a same dialog token.

The measurement setup identifier field carries a measurement setup identifier. In actual application, an identifier may be allocated to a sensing measurement setup, to distinguish between different sensing measurement setups.

The sensing measurement parameters element may include one or more sensing measurement parameters and/or sensing sub-elements. For example, the sensing measurement parameters field may include one or more of the following sensing measurement parameters: a sensing transmitter (sensing transmitter), a sensing receiver (sensing receiver), a sensing measurement report (sensing measurement report), a measurement report type (measurement report type), and a measurement setup expiry exponent (measurement setup expiry exponent).

In an implementation, when the first response message is the DMG sensing measurement setup response frame, the DMG sensing measurement setup response frame may include one or more fields shown in Table 2.

TABLE 2

| Sequence | Field name |
|---|---|
| 1 | Category (category) |
| 2 | Protected/Unprotected DMG action |
| | (Protected/Unprotected DMG Action) |
| 3 | Dialog token |
| 4 | DMG measurement setup identifier |
| 5 | State machine/status code |
| 6 | Sensing comeback information |
| 7 | DMG sensing measurement parameters element |
| 8 | DMG sensing image range axis lookup table (lookup |
| | table, LUT) (DMG Sensing Image Range Axis LUT) |
| 9 | DMG sensing image Doppler axis LUT (DMG Sensing |
| | Image Doppler Axis LUT) |
| 10 | DMG sensing instance duration element (DMG Sensing |
| | Instance Duration element) |

For specific meanings of the fields in Table 2, refer to related descriptions in the 802.11 series protocols. Details are not described herein. In the DMG sensing measurement setup response frame, the sensing comeback information field may also be referred to as a DMG sensing comeback information field or the like. This is not limited in this application. The sensing comeback information field may be located after the state machine/status code field, or may be located before the state machine/status code field, or may be located at any location of the action field (action field) of the DMG sensing measurement setup response frame. This is not specifically limited in this application.

In an implementation, the state machine/status code (briefly referred to as a status code below) in the first response message may include at least one of the following:
the status code is SUCCESS (SUCCESS), indicating that a sensing measurement setup request is accepted;
the status code is REQUEST_DECLINED (REQUEST_DECLINED), indicating that a sensing measurement setup request is rejected;
the status code is REJECTED_WITH_SUGGESTED_CHANGES (REJECTED_WITH_SUGGESTED_CHANGES), indicating that a sensing measurement setup request is rejected and a suggested measurement parameter is provided;
the status code is REQUEST_DECLINED_NORESOURCE (REQUEST_DECLINED_NORESOURCE), indicating that a sensing measurement setup request is rejected, and a rejection cause is that resources for the first apparatus to set up a sensing measurement as a sensing responder are full or no resource is available;
the status code is REJECTED_WITH_SUGGESTED_CHANGES NORESOURCE (REJECTED_WITH_SUGGESTED_CHANGES_NORESOURCE), indicating that a sensing by proxy measurement setup request is rejected, a rejection cause is that resources for the first apparatus to set up a sensing measurement as a sensing responder are full or no resource is available, and a suggested measurement parameter is provided;
the status code is REQUEST_DECLINED_INTERFERENCE (REQUEST_DECLINED_INTERFERENCE), indicating that a sensing measurement setup request is rejected, and a rejection cause is that the first apparatus or a sensing link is interfered with; or
the status code is REJECTED_WITH_SUGGESTED_CHANGES_INTERFERENCE (REJECTED_WITH_SUGGESTED_CHANGES_INTERFERENCE), indicating that a sensing by proxy measurement setup request is rejected, a rejection cause is that the first apparatus or a sensing link is interfered with, and a suggested measurement parameter is provided.

The foregoing is merely an example. The status code may alternatively indicate other content. This is not limited in this application.

Optionally, step 203: The second apparatus sends the second request message to the first apparatus.

Correspondingly, the first apparatus receives the second request message from the second apparatus.

In an implementation, the second request message is a message used to request to set up a sensing measurement. For example, the second request message may be a sensing measurement setup request frame or a DMG sensing measurement setup request frame.

The second request message may include a sensing measurement parameter used for sensing measurement. How to specifically determine the sensing measurement parameter is not limited in this application. For example, it is assumed that the first request message further includes a first sensing measurement parameters element field, and the first sensing measurement parameters element field includes at least one sensing measurement parameter; and the second request message includes a second sensing measurement parameters element field, the first response message includes a third sensing measurement parameters element field, and the third sensing measurement parameters element field includes at least one sensing measurement parameter. In this case, a sensing measurement parameters element included in the second sensing measurement parameters element field may be determined according to any one of the following implementations.

Implementation 1: If the status code in the first response message indicates that a sensing measurement setup request is rejected, and the first indication information indicates the second apparatus to resend the second request message for setting up a sensing measurement, a sensing measurement parameter in the second sensing measurement parameters element field is determined based on the at least one sensing measurement parameter in the first sensing measurement parameters element field.

For example, when the first apparatus re-initiates a sensing measurement setup request, the sensing measurement parameter in the second sensing measurement parameters element field may be completely or partially the same as the sensing measurement parameter in the first sensing measurement parameters element field.

Implementation 2: If the status code in the first response message indicates that a sensing measurement setup request is rejected and a suggested measurement parameter is provided, and the first indication information indicates the second apparatus to resend the second request message for setting up a sensing measurement, a sensing measurement parameter in the second sensing measurement parameters element field is determined based on the at least one sensing measurement parameter in the third sensing measurement parameters element field.

For example, when the first apparatus re-initiates a sensing measurement setup request, the sensing measurement parameter in the second sensing measurement parameters element field may be completely or partially the same as the sensing measurement parameter in the third sensing measurement parameters element field.

Implementation 3: If the status code in the first response message indicates that a sensing measurement setup request is rejected, and a rejection cause is that resources for the first apparatus to set up a sensing measurement as a sensing responder are full, a sensing measurement parameter in the second sensing measurement parameters element field is determined based on the at least one sensing measurement parameter in the first sensing measurement parameters element field.

Implementation 4: If the status code in the first response message indicates that a sensing measurement setup request is rejected, a rejection cause is that resources for the first apparatus to set up a sensing measurement as a sensing responder are full, and a suggested measurement parameter is provided, a sensing measurement parameter in the second sensing measurement parameters element field is determined based on the at least one sensing measurement parameter in the third sensing measurement parameters element field.

Implementation 5: If the status code in the first response message indicates that a sensing measurement setup request is rejected, and a rejection cause is that the first apparatus or a sensing link is interfered with, a sensing measurement parameter in the second sensing measurement parameters element field is determined based on the at least one sensing measurement parameter in the first sensing measurement parameters element field.

Implementation 6: If the status code in the first response message indicates that a

sensing measurement setup request is rejected, a rejection cause is that the first apparatus or a sensing link is interfered with, and a suggested measurement parameter is provided, a sensing measurement parameter in the second sensing measurement parameters element field is determined based on the at least one sensing measurement parameter in the third sensing measurement parameters element field.

The foregoing is merely an example. The sensing measurement parameter in the second sensing measurement parameters element field may alternatively be determined in another manner. This is not limited in this application.

In an implementation, the sending time of the second request message is determined by the second apparatus based on the first indication information in the first response message. For example, if the first indication information indicates the second apparatus to resend the request message for setting up a sensing measurement, the second apparatus may send the second request message within the first time and the second time. For another example, if the first indication information indicates the second apparatus not to resend the request message for setting up a sensing measurement, and the status code in the first response message indicates that the sensing measurement setup request is rejected, the second apparatus may send the second request message after a third time, where the third time may be preset. For example, the third time may be before the second time, or the third time may be after the second time.

For example, the second indication information indicates 2048 ms, the third indication information indicates 4096 ms, and the preset time reference point is the start moment Tref at which the second apparatus receives the first response message. If the first indication information indicates the second apparatus to resend the request message for setting up a sensing measurement, the second apparatus may send the second request message between Tref+2048 ms and Tref+4096 ms; or if the first indication information indicates the second apparatus not to resend the request message for setting up a sensing measurement, and the status code in the first response message indicates that the sensing measurement setup request is rejected, the second apparatus may send the second request message after Tref+4096 ms (in this example, the third time is 4096 ms).

Optionally, step 204: The first apparatus sends a second response message to the second apparatus.

Correspondingly, the second apparatus receives the second response message from the first apparatus.

The second response message is a message in response to the second request message. For example, the second response message may be a sensing measurement setup response frame or a DMG sensing measurement setup response frame.

According to the method provided in this application, when the first apparatus rejects the sensing measurement setup, the first indication information indicates the second apparatus whether to re-initiate a sensing measurement setup request, thereby implementing information exchange between the sensing responder and the sensing initiator. In this way, when the sensing measurement setup is rejected by the sensing responder, the sensing initiator may more clearly determine an intention of the sensing responder based on the first indication information, thereby ensuring an efficient subsequent sensing measurement setup, and avoiding repeatedly initiating a sensing measurement setup request a plurality of times in a case of rejection. This can reduce resources consumed for setting up a sensing measurement.

In an SBP setup process, an SBP initiator (generally a STA) sends an SBP request frame to an SBP responder (generally an AP), and the SBP responder replies to the SBP initiator with an SBP response frame. Similarly, the method procedure shown in FIG. 2 is also applicable to the SBP setup process.

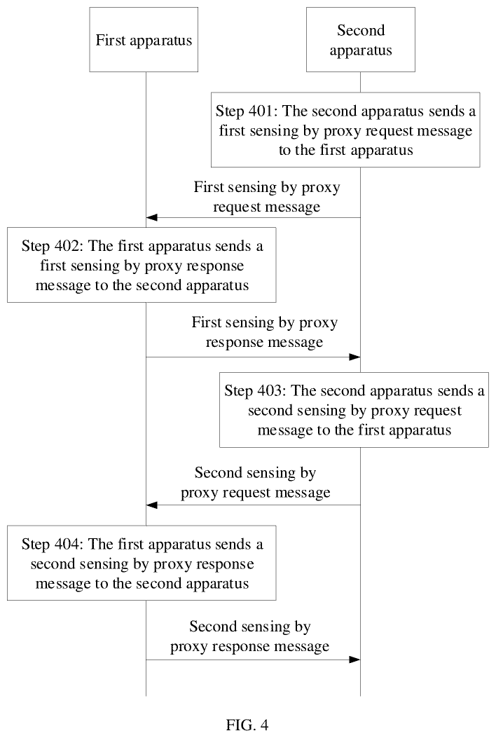

FIG. 4 is a schematic flowchart of a sensing method according to an embodiment of this application. When the method procedure provided in this embodiment of this application is applied to the system shown in FIG. 1, the AP or the chip in the AP in FIG. 1 may perform a method performed by a first apparatus in the following procedure, and the STA or the chip in the STA in FIG. 1 may perform a method performed by a second apparatus in the following procedure. It may be understood that a specific structure of an execution body of the method provided in this embodiment of this application is not specifically limited in the following embodiments, provided that a program that records code for the method provided in this embodiment of this application can be run to perform communication according to the method provided in this embodiment of this application. The method includes the following steps.

Step 401: The second apparatus sends a first sensing by proxy request message to the first apparatus.

Correspondingly, the first apparatus receives the first sensing by proxy request message from the second apparatus.

In an implementation, in the procedure in FIG. 4, the second apparatus may be an SBP initiator, and the first apparatus may be an SBP responder.

In an implementation, the first sensing by proxy request message is used to request the first apparatus to set up a sensing by proxy measurement or perform a sensing by proxy measurement. For example, the first sensing by proxy request message may be an SBP request frame or a DMG SBP request frame.

Step 402: The first apparatus sends a first sensing by proxy response message to the second apparatus.

Correspondingly, the second apparatus receives the first sensing by proxy response message from the first apparatus.

The first sensing by proxy response message is a message in response to the first sensing by proxy request message. For example, the first sensing by proxy response message may be an SBP response frame or a DMG SBP response frame.

In an implementation, the first apparatus rejects the first sensing by proxy request message, that is, the first apparatus rejects the sensing by proxy measurement setup requested by the second apparatus. The first sensing by proxy response message includes first information, and the first information indicates the second apparatus to resend a sensing by proxy request message (for example, a second sensing by proxy request message) for requesting the first apparatus to set up a sensing by proxy measurement, or the first information indicates the second apparatus not to resend a sensing by proxy request message for requesting the first apparatus to set up a sensing by proxy measurement.

That the first information indicates the second apparatus to resend the sensing by proxy request message for requesting the first apparatus to set up a sensing by proxy measurement may be replaced with a description having a same meaning as “the first information indicates the second apparatus to re-initiate a sensing measurement setup by proxy”. That the first information indicates the second apparatus not to resend the sensing by proxy request message for requesting the first apparatus to set up a sensing by proxy measurement may be replaced with a description having a same meaning as “the first information indicates the second apparatus not to re-initiate a sensing measurement setup by proxy”. This is not limited in this application.

In an implementation, when the first information indicates the second apparatus to resend the sensing by proxy request message for requesting the first apparatus to set up a sensing by proxy measurement, a sending time of the second sensing by proxy request message is greater than or equal to a first time, and is less than or equal to a second time, where the first time and the second time are preset, or may be indicated by the first apparatus. The second time is after the first time.

In an implementation, the first sensing by proxy response message further includes at least one of second information and third information; and
the second information indicates the first time, and the third information indicates the second time.

In an implementation, the first sensing by proxy response message may include a sensing comeback information field. The sensing comeback information field may include a comeback (comeback) subfield, an initiator/STA n comeback after exponent (Initiator/STA Comeback After Exponent) subfield, and an initiator/STA comeback after exponent (Initiator/STA Comeback Before Exponent) subfield. The comeback subfield is used to carry the first indication information, the initiator/STA comeback after exponent subfield is used to carry the second indication information, and the initiator/STA comeback before exponent subfield is used to carry the third indication information. The sensing comeback information field may further include another subfield, for example, a reserved (reserved) subfield. For specific content of the sensing comeback information field, refer to the foregoing description in Table 1, and details are not described herein.

Names of the foregoing fields and subfields are merely examples, and may have other names. This is not limited in this application. For example, the initiator/STA comeback after exponent may also be referred to as comeback after exponent, and the initiator/STA comeback before exponent may also be referred to as comeback before exponent.

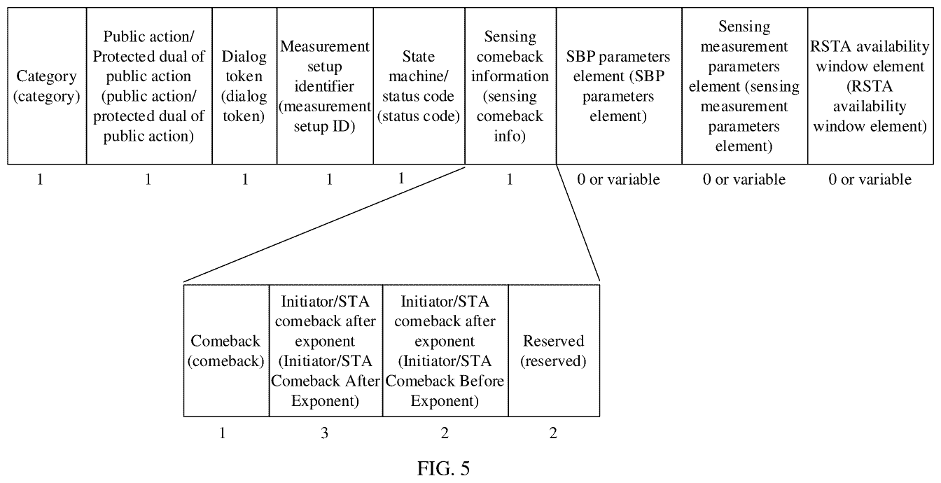

In an implementation, when the first response message is the SBP response frame, the first response message may be shown in FIG. 5. FIG. 5 is an example diagram of a structure of an SBP response frame according to an embodiment of this application. The sensing measurement setup response frame may include one or more of the following fields: a category (category), a public action/protected dual of public action, a dialog token, a measurement setup identifier (identifier, ID), a state machine/status code (status code for short below), sensing comeback information, an SBP parameters element (SBP parameters element), a sensing measurement parameters element (sensing measurement parameters element), and a responding station (Responding STA, RSTA) availability window element (RSTA availability window element).

A structure of an action field of the SBP response frame is merely an example. The sensing comeback information field may be located after the state machine/status code field, or may be located before the state machine/status code field, or may be located at any location of the action field (action field) of the SBP response frame, as shown in the example in the figure. This is not specifically limited in this application.

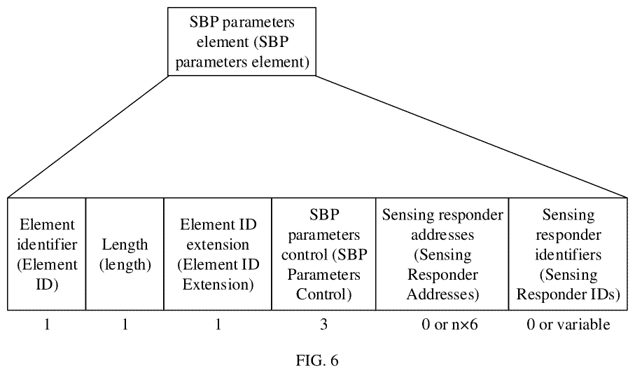

In an implementation, as shown in FIG. 6, the SBP parameters element field may include one or more of the following fields: an element identifier (Element ID), a length (length), element ID extension (Element ID Extension), SBP parameters control (SBP Parameters Control), sensing responder addresses (Sensing Responder Addresses), and sensing responder identifiers (Sensing Responder IDs).

The sensing responder address includes at least one address subfield, and each address subfield includes an address of one sensing responder, for example, the address may be a medium access control (medium access control, MAC) address. The sensing responder identifier includes at least one address subfield, and each address subfield includes an identifier of one sensing responder, for example, may be an association ID (association ID, AID) or an unassociated ID (unassociated ID, USID) of the sensing responder.

In this application, specific meanings of the fields included in the SBP response frame are not specifically limited in this application. Details are not described herein.

In an implementation, when the first sensing by proxy response message is the DMG SBP response frame, the DMG SBP response frame may include one or more fields shown in Table 3.

TABLE 3

| Sequence | Field name |
|---|---|
| 1 | Category (category) |
| 2 | Protected/Unprotected DMG action |
| | (Protected/Unprotected DMG Action) |
| 3 | Dialog token |
| 4 | DMG measurement setup identifier |
| 5 | State machine/status code |
| 6 | Sensing comeback information |
| 7 | DMG SBP parameters element |
| 8 | DMG sensing measurement parameters element |
| 9 | DMG sensing image range axis lookup table (lookup |
| | table, LUT) (DMG Sensing Image Range Axis LUT) |
| 10 | DMG sensing image Doppler axis LUT (DMG Sensing |
| | Image Doppler Axis LUT) |

The DMG SBP parameters element table in Table 3 may further include fields such as the SBP parameters control, the sensing responder address, and the sensing responder identifier. For details, refer to the foregoing description. For specific meanings of the other fields in Table 3, refer to related descriptions in the 802.11 series protocols. Details are not described herein.

In the DMG SBP response frame, the sensing comeback information field may also be referred to as a DMG sensing comeback information field or the like. This is not limited in this application. The sensing comeback information field may be located after the state machine/status code field, or may be located before the state machine/status code field, or may be located at any location of the action field (action field) of the DMG SBP response frame. This is not specifically limited in this application.

In an implementation, the status code in the first sensing by proxy response message may include at least one of the following:
the status code is SUCCESS (SUCCESS), indicating that a sensing by proxy measurement setup request is accepted;
the status code is REQUEST_DECLINED (REQUEST_DECLINED), indicating that a sensing by proxy measurement setup request is rejected;
the status code is REJECTED_WITH_SUGGESTED_CHANGES (REJECTED_WITH_SUGGESTED_CHANGES), indicating that a sensing by proxy measurement setup request is rejected and a suggested SBP parameter and/or sensing measurement parameter is provided;
the status code is REQUEST_DECLINED_NORESOURCE (REQUEST_DECLINED_NORESOURCE), indicating that a sensing by proxy measurement setup request is rejected, and a rejection cause is that resources for the first apparatus to set up a sensing measurement as a sensing responder are full or no resource is available;
the status code is REJECTED_WITH_SUGGESTED_CHANGES_NORESOURCE (REJECTED_WITH_SUGGESTED_CHANGES_NORESOURCE), indicating that a sensing by proxy measurement setup request is rejected, a rejection cause is that resources for the first apparatus to set up a sensing measurement as a sensing responder are full or no resource is available, and a suggested SBP parameter and/or sensing measurement parameter is provided;
the status code is REQUEST_DECLINED_INTERFERENCE (REQUEST_DECLINED_INTERFERENCE), indicating that a sensing by proxy measurement setup request is rejected, and a rejection cause is that the first apparatus or a sensing link is interfered with; or
the status code is REJECTED_WITH_SUGGESTED_CHANGES_INTERFERENCE (REJECTED_WITH_SUGGESTED_CHANGES_INTERFERENCE), indicating that a sensing by proxy measurement setup request is rejected, a rejection cause is that the first apparatus or a sensing link is interfered with, and a suggested SBP parameter and/or sensing measurement parameter is provided.

In an implementation, the first sensing by proxy response message includes a number of sensing responders (Number of Sensing Responders) field. The number of sensing responders field indicates a number of sensing responders, and the number of sensing responders field may be located in the SBP parameters control field.

In this implementation, the first sensing by proxy response message may be an SBP response frame or a DMG SBP response frame.

In this implementation, if the status code in the first sensing by proxy response message indicates that the sensing by proxy measurement setup request is rejected and the suggested SBP parameter and/or sensing measurement parameter is provided, a number of address subfields included in the sensing responder address field in the first sensing by proxy response message is equal to the number of sensing responders indicated by the number of sensing responders field in the first sensing by proxy response message; and/or a number of identifier subfields included in the sensing responder identifier field in the first sensing by proxy response message is equal to the number of sensing responders indicated by the number of sensing responders field in the first sensing by proxy sensing response message.

That is, the sensing responder address field includes an address of the sensing responder suggested by the SBP responder (the first apparatus); and the sensing responder identifier field includes an identifier of the sensing responder suggested by the SBP responder (the first apparatus).

Similarly, an SBP termination frame (SBP Termination frame) may also include an SBP parameters element field. The SBP parameters element field in the SBP termination frame may include at least one of a sensing responder address and a sensing responder identifier. In this case, a number of address subfields included in the sensing responder address field in the SBP termination frame is equal to a number of sensing responders indicated by a number of sensing responders field in the SBP termination frame, and/or a number of identifier subfields included in the sensing responder identifier field in the SBP termination frame is equal to a number of sensing responders indicated by a number of sensing responders field in the SBP termination frame. That is, the sensing responder address field includes an address of the sensing responder suggested by the SBP responder (the first apparatus); and the sensing responder identifier field includes an identifier of the sensing responder suggested by the SBP responder (the first apparatus).

The SBP termination frame may also be referred to as a name such as an SBP termination frame. This is not limited in this application.

The SBP termination frame described above may be replaced with a “DMG SBP termination frame”.

Optionally, step 403: The second apparatus sends the second sensing by proxy request message to the first apparatus.

Correspondingly, the first apparatus receives the second sensing by proxy request message from the second apparatus.

In an implementation, the second sensing by proxy request message is a message used to request to set up a sensing by proxy measurement. For example, the second sensing by proxy request message may be an SBP request frame or a DMG SPB request frame.

The second sensing by proxy request message may include a sensing measurement parameters element used for sensing measurement and an SBP parameters element. How to specifically determine the sensing measurement parameter is not limited in this application. For example, it is assumed that the first sensing by proxy request message further includes a first SBP parameters element and/or a first sensing measurement parameters element, the first SBP parameters element field includes at least one SBP parameter, and the first sensing measurement parameters element field includes at least one sensing measurement parameter; and the second sensing by proxy request message includes a second SBP parameters element field and/or a second sensing measurement parameters element field, the second SBP measurement parameters element field includes at least one SBP parameter, the first sensing by proxy response message includes a third SBP parameters element field and/or a third sensing measurement parameters element field, the third SBP measurement parameters element field includes at least one SBP parameter, and the third sensing measurement parameters element field includes at least one sensing measurement parameter. In this case, an SBP parameter included in the second SBP parameters element and/or a sensing measurement parameter included in the second sensing measurement parameters element field may be determined according to any one of the following implementations.

Implementation 1: If the status code in the first sensing by proxy response message indicates that a sensing measurement setup request is rejected, and the first information indicates the second apparatus to resend the second sensing by proxy request message for requesting the first apparatus to set up a sensing by proxy measurement, the SBP parameter in the second SBP parameters element field is determined based on the at least one SBP parameter in the first SBP parameter elements field, and/or the sensing measurement parameter in the second sensing measurement parameters element field is determined based on the at least one sensing measurement parameter in the first sensing measurement parameters element field.

For example, when the first apparatus re-initiates a sensing by proxy measurement setup request, the SBP parameter in the second SBP parameters element field may be completely or partially the same as the SBP parameter in the first SBP parameters element field, and the sensing measurement parameter in the second sensing measurement parameters element field may be completely or partially the same as the sensing measurement parameter in the first sensing measurement parameters element field.

Implementation 2: If the status code in the first sensing by proxy response message indicates that a sensing measurement setup request is rejected and a suggested SBP parameter and/or sensing measurement parameter are/is provided, and the first information indicates the second apparatus to resend the second sensing by proxy request message for requesting the first apparatus to set up a sensing by proxy measurement, the SBP parameter in the second SBP parameters element field is determined based on the at least one SBP parameter in the third SBP parameter elements field, and/or the sensing measurement parameter in the second sensing measurement parameters element field is determined based on the at least one sensing measurement parameter in the third sensing measurement parameters element field.

For example, when the first apparatus re-initiates a sensing by proxy measurement setup request, the SBP parameter in the second SBP parameters element field may be completely or partially the same as the SBP parameter in the third SBP parameters element field, and the sensing measurement parameter in the second sensing measurement parameters element field may be completely or partially the same as the sensing measurement parameter in the third sensing measurement parameters element field.

Implementation 3: If the status code in the first sensing by proxy response message indicates that a sensing measurement setup request is rejected, and a rejection cause is that resources for the first apparatus to set up a sensing measurement as a sensing responder are full, the SBP parameter in the second SBP parameters element field is determined based on the at least one SBP parameter in the first SBP parameter elements field, and/or the sensing measurement parameter in the second sensing measurement parameters element field is determined based on the at least one sensing measurement parameter in the first sensing measurement parameters element field.

Implementation 4: If the status code in the first sensing by proxy response message indicates that a sensing measurement setup request is rejected, a rejection cause is that resources for the first apparatus to set up a sensing measurement as a sensing responder are full, and a suggested SBP parameter and/or sensing measurement parameter are/is provided, the SBP parameter in the second SBP parameters element field is determined based on the at least one SBP parameter in the third SBP parameter elements field, and/or the sensing measurement parameter in the second sensing measurement parameters element field is determined based on the at least one sensing measurement parameter in the third sensing measurement parameters element field.

Implementation 5: If the status code in the first sensing by proxy response message indicates that a sensing measurement setup request is rejected, and a rejection cause is that the first apparatus or a sensing link is interfered with, the SBP parameter in the second SBP parameters element field is determined based on the at least one SBP parameter in the first SBP parameter elements field, and/or the sensing measurement parameter in the second sensing measurement parameters element field is determined based on the at least one sensing measurement parameter in the first sensing measurement parameters element field.

Implementation 6: If the status code in the first sensing by proxy response message indicates that a sensing measurement setup request is rejected, a rejection cause is that the first apparatus or a sensing link is interfered with, and a suggested SBP parameter and/or sensing measurement parameter are/is provided, the SBP parameter in the second SBP parameters element field is determined based on the at least one SBP parameter in the third SBP parameter elements field, and/or the sensing measurement parameter in the second sensing measurement parameters element field is determined based on the at least one sensing measurement parameter in the third sensing measurement parameters element field.

The foregoing is merely an example. The SBP parameter in the second SBP parameters element field and the sensing measurement parameter in the second sensing measurement parameters element field may alternatively be determined in another manner. This is not limited in this application.

In an implementation, the sending time of the second sensing by proxy request message is determined by the second apparatus based on the first information in the first sensing by proxy response message. For example, if the first information indicates the second apparatus to resend the second sensing by proxy request message for requesting the first apparatus to set up a sensing by proxy measurement, the second apparatus may send the second sensing by proxy request message within the first time and the second time. For another example, if the first information indicates the second apparatus not to resend the second sensing by proxy request message for requesting the first apparatus to set up a sensing by proxy measurement, and the status code in the first response message indicates that the sensing measurement setup request is rejected and the suggested SBP parameter and/or sensing measurement parameter are/is provided, the second apparatus may send the second sensing by proxy request message after a third time, where the third time may be preset. For example, the third time may be before the second time, or the third time may be after the second time.

Optionally, step 404: The first apparatus sends a second sensing by proxy response message to the second apparatus.

Correspondingly, the second apparatus receives the second sensing by proxy response message from the first apparatus.

The second sensing by proxy response message is a message in response to the second sensing by proxy request message. Specific content of the second sensing by proxy response message is not limited in this application, and details are not described herein.

According to the method provided in this application, when the first apparatus rejects the sensing by proxy measurement setup, the first indication information indicates the second apparatus whether to re-initiate a sensing by proxy measurement setup request, thereby implementing information exchange between an SBP responder and an SBP initiator. In this way, when the sensing by proxy measurement setup is rejected by the SBP responder, the SBP initiator may more clearly determine an intention of the sensing responder based on the first indication information, thereby ensuring an efficient subsequent sensing by proxy measurement setup, and avoiding repeatedly initiating a sensing by proxy measurement setup request a plurality of times in a case of rejection. This can reduce resources consumed for setting up a sensing by proxy measurement.

When the sensing initiator initiates a sensing measurement setup, if sensing resources of an apparatus have been used up as a sensing responder (for example, a number of sensing setups has reached a maximum number of supported setups as a sensing responder (Max Number of Supported Setups as Responder)), but the apparatus still has resources as a sensing initiator, the apparatus may also initiate a sensing measurement setup as a sensing initiator to initiate a symmetrical sensing measurement to assist the original sensing initiator to complete the sensing measurement. Details are described below.

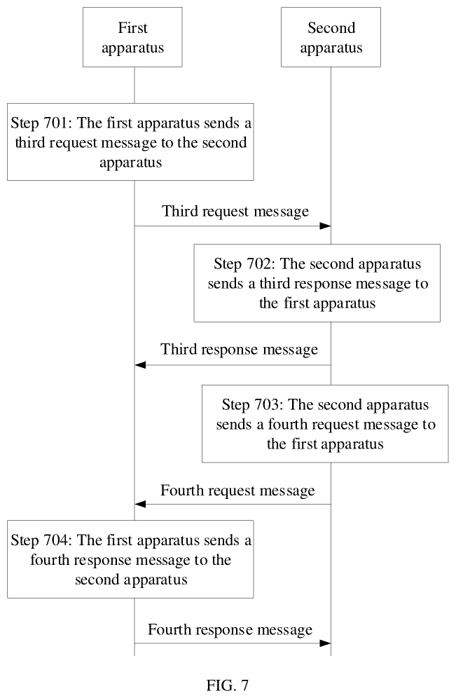

FIG. 7 is a schematic flowchart of a sensing method according to an embodiment of this application. When the method procedure provided in this embodiment of this application is applied to the system shown in FIG. 1, the AP or the chip in the AP or the STA or the chip in the STA in FIG. 1 may perform a method performed by a first apparatus in the following procedure, and the AP or the chip in the AP or the STA or the chip in the STA in FIG. 1 may perform a method performed by a second apparatus in the following procedure. It may be understood that a specific structure of an execution body of the method provided in this embodiment of this application is not specifically limited in the following embodiments, provided that a program that records code for the method provided in this embodiment of this application can be run to perform communication according to the method provided in this embodiment of this application. The method includes the following steps.

Step 701: The first apparatus sends a third request message to the second apparatus.

Correspondingly, the second apparatus receives the third request message from the first apparatus.

In an implementation, the first apparatus may be a sensing initiator, and the second apparatus may be a sensing responder.

In an implementation, the third request message is used to request to set up a first sensing measurement, that is, the third request message is a message used to request to set up a sensing measurement. For example, the third request message may be a sensing measurement setup request frame or a DMG sensing measurement setup request frame.

In an implementation, the third request message includes measurement request indication information, and the measurement request indication information indicates the second apparatus to initiate a sensing measurement setup as a sensing initiator when the second apparatus cannot accept a first request message or a sensing measurement setup as a sensing responder. In another implementation, if the first apparatus does not expect the second apparatus to initiate a sensing measurement setup, the measurement request indication information indicates that no additional procedure is required when the second apparatus cannot accept a first request message or a sensing measurement setup as a sensing responder.

The third request message further includes a first measurement setup identifier, and the first measurement setup identifier is an identifier of the sensing measurement setup requested by the third request message.

Step 702: The second apparatus sends a third response message to the first apparatus.

Correspondingly, the first apparatus receives the third response message from the second apparatus.

The third response message is a message in response to the third request message. For example, the third response message may be a sensing measurement setup response frame or a DMG sensing measurement setup response frame.

In an implementation, the third response message indicates that the third request message is rejected, that is, the third response message indicates that the sensing measurement setup requested by the first apparatus is rejected. For example, if the second apparatus determines that sensing resources of the second apparatus have been used up as a sensing responder, for example, a number of sensing setups has reached a maximum number of supported setups as a sensing responder, the second apparatus may reject the third request message by using the third response message.

The third response message may include measurement confirmation indication information. For example, the second apparatus still has resources as a sensing initiator, and the measurement confirmation indication information may indicate that the second apparatus is to initiate a sensing measurement setup as a sensing initiator. For another example, the second apparatus does not expect to serve as a sensing initiator, and the measurement confirmation indication information may indicate that the second apparatus is not to initiate a sensing measurement setup as a sensing initiator.

When the third response message is the sensing measurement setup response frame, the measurement confirmation indication information may be located at any location in the sensing measurement setup response frame. This is not limited in this application.

Similarly, when the third response message is the DMG sensing measurement setup response frame, the measurement confirmation indication information may be located at any location in the DMG sensing measurement setup response frame. This is not limited in this application. For example, the measurement confirmation indication information may be located at a reserved bit in a measurement setup ID field in the DMG sensing measurement setup response frame, or may be located at any location in a DMG sensing measurement setup element field, a DMG sensing image range axis LUT field, a DMG sensing image Doppler axis LUT field, or a DMG sensing instance duration element field.

In an implementation, the third response message may include a sensing comeback information field. For details, refer to FIG. 3 or Table 2. Details are not described herein.

In an implementation, the third response message may include a status code. If the measurement confirmation indication information indicates that the second apparatus is to initiate a sensing measurement setup as a sensing initiator, the status code in the third response message may be REQUEST_DECLINED_NORESOURCE (REQUEST_DECLINED_NORESOURCE) or REJECTED_WITH_SUGGESTED_CHANGES_NORESOURCE (REJECTED_WITH_SUGGESTED_CHANGES_NORESOURCE). For a meaning of the status code, refer to the description of the status code in step 202. Details are not described herein.

In this application, if the second apparatus still has resources as a sensing initiator, and the second apparatus expects to initiate a sensing measurement setup as a sensing initiator, the following procedure may be further included:

Step 703: The second apparatus sends a fourth request message to the first apparatus.

Correspondingly, the first apparatus receives the fourth request message from the second apparatus.

In an implementation, the second apparatus may be a sensing initiator, and the first apparatus may be a sensing responder.

The fourth request message is used to request to set up a second sensing measurement. For example, the fourth request message may be a sensing measurement setup request frame or a DMG sensing measurement setup request frame.

The fourth request message includes measurement indication information, and the measurement indication information indicates that the second sensing measurement that the fourth request message requests to set up is associated with the first sensing measurement, or the measurement indication information indicates that the second sensing measurement that the fourth request message requests to set up is a sensing measurement symmetrical to the first sensing measurement. The measurement indication information may indicate that the fourth request message is a request message in a symmetrical measurement procedure, and a sensing measurement setup procedure initiated by the fourth request message is a sensing measurement procedure symmetrical to the first sensing measurement setup.

Correspondingly, if the second sensing measurement that the fourth request message requests to set up is not associated with or asymmetrical to the first sensing measurement, the measurement indication information indicates that the second sensing measurement that the fourth request message requests to set up is not associated with or asymmetrical to the first sensing measurement, and the fourth request message is a sensing measurement setup request frame in an asymmetrical sensing measurement setup procedure, that is, a general sensing measurement setup request frame.

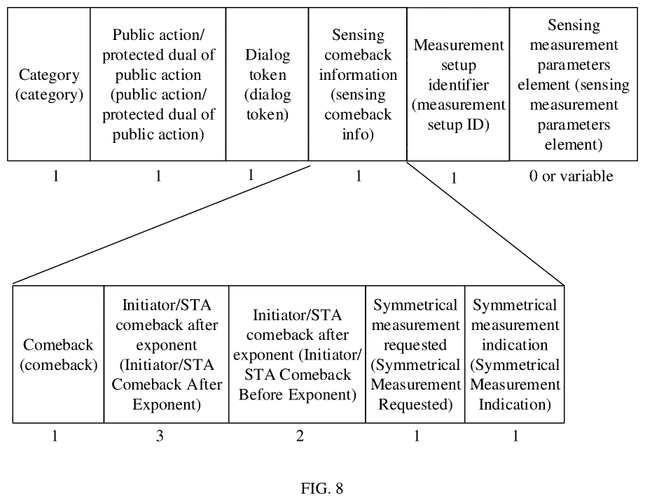

With reference to the foregoing description, in an implementation, when the fourth request message is the sensing measurement setup request frame, a specific structure may be shown in FIG. 8. FIG. 8 is an example diagram of a structure of a sensing measurement setup request frame according to an embodiment of this application. The sensing measurement setup request frame may include one or more of the following fields: a category, a public action/protected dual of public action, a dialog token, sensing comeback information, a measurement setup identifier, and a sensing measurement parameters element.

A structure of an action field of the sensing measurement setup request frame is merely an example. The sensing comeback information field may be located after the dialog token field, or may be located before the dialog token field, or may be located at any location of the action field (action field) of the sensing measurement setup response frame, as shown in the example in the figure. This is not specifically limited in this application.

The sensing comeback information field may include a comeback subfield, an initiator/STA comeback after exponent subfield, an initiator/STA comeback before exponent subfield, a symmetrical measurement requested (Symmetrical Measurement Requested) subfield, and a symmetrical measurement indication (Symmetrical Measurement Indication) subfield. The symmetrical measurement requested subfield may be used to carry the measurement request indication information, and the symmetrical measurement indication subfield is used to carry the measurement indication information. Specific meanings of the comeback subfield, the initiator/STA comeback after exponent subfield, the initiator/STA comeback before exponent subfield are not described. For details, refer to the foregoing descriptions, or refer to descriptions in the 802.11 series standards. Names of the foregoing fields and subfields are merely examples, and may have other names. This is not limited in this application.

In an implementation, the fourth request message further includes a second measurement setup identifier and a first measurement setup identifier. The second measurement setup identifier is an identifier of the sensing measurement setup requested by the fourth request message. By using this method, the sensing measurement setup requested by the fourth request message may be associated with the sensing measurement setup requested by the third request message, that is, the sensing measurement setup requested by the fourth request message is a sensing measurement setup symmetrical to the sensing measurement setup requested by the third request message.

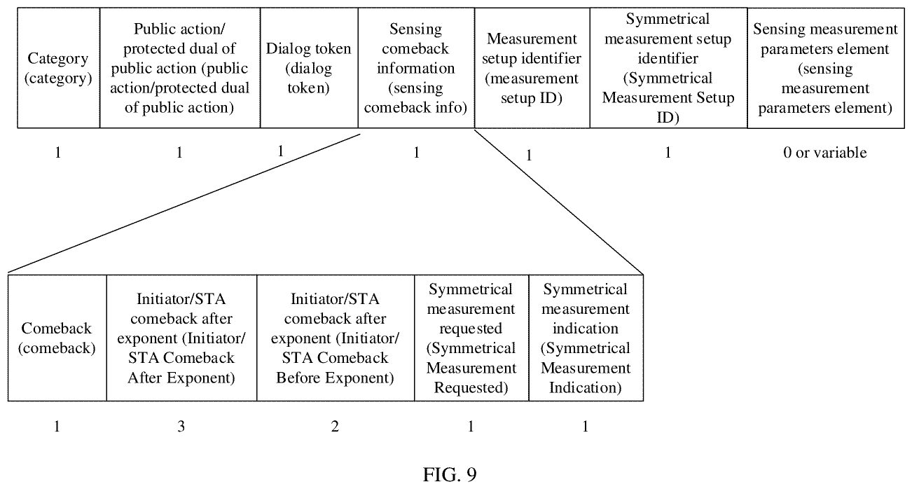

For example, when the fourth request message is the sensing measurement setup request frame, a specific structure may be shown in FIG. 9. FIG. 9 is an example diagram of a structure of a sensing measurement setup request frame according to an embodiment of this application. The sensing measurement setup request frame may include one or more of the following fields: a category, a public action/protected dual of public action, a dialog token, a status code, sensing comeback information, a measurement setup identifier, a symmetrical measurement setup identifier (Symmetrical Measurement Setup ID), and a sensing measurement parameters element. The measurement setup identifier includes a second measurement setup identifier, and the symmetrical measurement setup identifier includes a first measurement setup identifier.

In an implementation, the foregoing method may also be applied to a DMG sensing measurement setup procedure. When the third request message and the fourth request message are DMG sensing measurement setup request frames,
the measurement request indication information and the measurement indication information may be located at any location of the DMG sensing measurement setup request frame. For example, the measurement request indication information and the measurement indication information may be located in a reserved bit in a measurement setup ID field of the DMG sensing measurement setup request frame, or may be located in a DMG sensing measurement setup element of the DMG sensing measurement setup request frame. Other cases are not described.

In an implementation, a new feedback phase may be added during a symmetrical measurement. An example in which a STA initiates an NTB sensing measurement setup request is used. If resources of an AP have been used up as a sensing responder, the AP may initiate a symmetrical TB measurement according to the method described in FIG. 7, to assist the STA in completing a sensing measurement.

In the NTB measurement, if the STA needs to measure a channel between the STA and the AP as an initiator, and resources of the AP have been used up as a responder, the AP may set up a symmetrical TB measurement as an initiator, to assist the STA in completing a measurement. The TB measurement needs to include a TF sounding phase, and a parameter in an NTB SMS request frame initiated by the STA needs to be used for a parameter in the set-up TB measurement.

If a sensing measurement report requested subfield of a sensing measurement parameters element in the sensing measurement setup request sent by the STA is 0, an existing procedure may be kept unchanged.

If the sensing measurement report requested subfield of the sensing measurement parameters element in the sensing measurement setup request sent by the STA is 1, the AP needs to feed back a measurement result to the STA. Manner 1: Higher-layer feedback. Manner 2: Feedback procedure of adding an AP to the STA: For example, an existing sensing report frame is reused to feed back a measurement result to the STA.

If the STA needs to measure a channel between the AP and the STA as an initiator, and resources of the AP have been used up as a responder, the AP may set up a symmetrical TB measurement as an initiator, to assist the STA in completing a measurement. The TB measurement needs to include an NDPA sounding phase, and a parameter in an NTB sensing measurement setup request frame initiated by the STA needs to be used for a parameter in the set-up TB measurement.

Optionally, step 704: The first apparatus sends a fourth response message to the second apparatus.

Correspondingly, the second apparatus receives the fourth response message from the first apparatus.

The fourth response message is a message in response to the fourth message. Specific content of the fourth response message is not limited in this application, and details are not described herein.

According to the foregoing method, when the first apparatus initiates the sensing measurement setup, the third request message may carry the measurement request indication information, to indicate the second apparatus to initiate the sensing measurement setup as a sensing initiator when the second apparatus cannot accept the first request message or the sensing measurement setup as a sensing responder. In this way, when the second apparatus rejects the sensing measurement requested by the first apparatus, the second apparatus may initiate a symmetrical sensing measurement as a sensing initiator, to assist the first apparatus in completing the sensing measurement, thereby resolving a problem of how to implement a sensing measurement setup when resources of the sensing responder are full.

When the sensing measurement setup initiated by the sensing initiator is rejected, a message may be separately sent to indicate the sensing responder to initiate a symmetrical sensing measurement setup as a sensing initiator, to assist the original sensing initiator in completing the sensing measurement. Details are described below.

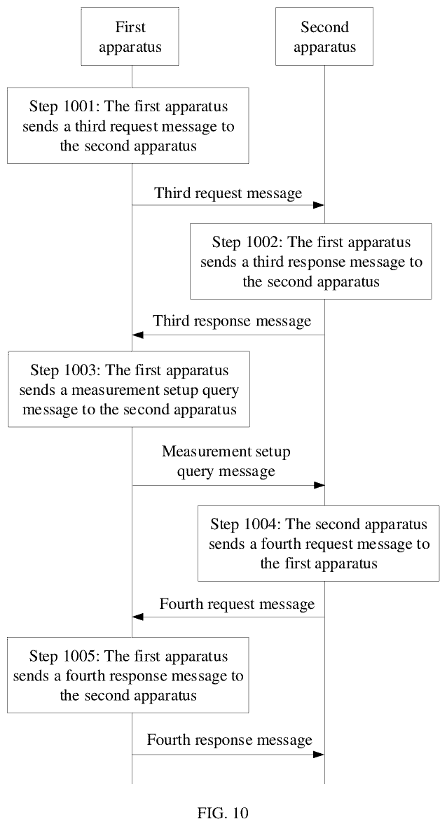

FIG. 10 is a schematic flowchart of a sensing method according to an embodiment of this application. When the method procedure provided in this embodiment of this application is applied to the system shown in FIG. 1, the AP or the chip in the AP or the STA or the chip in the STA in FIG. 1 may perform a method performed by a first apparatus in the following procedure, and the AP or the chip in the AP or the STA or the chip in the STA in FIG. 1 may perform a method performed by a second apparatus in the following procedure. It may be understood that a specific structure of an execution body of the method provided in this embodiment of this application is not specifically limited in the following embodiments, provided that a program that records code for the method provided in this embodiment of this application can be run to perform communication according to the method provided in this embodiment of this application. The method includes the following steps.

Step 1001: The first apparatus sends a third request message to the second apparatus.

Correspondingly, the second apparatus receives the third request message from the first apparatus.

In an implementation, the third request message is used to request to set up a first sensing measurement, that is, the third request message is a message used to request to set up a sensing measurement. For example, the third request message may be a sensing measurement setup request frame or a DMG sensing measurement setup request frame.

In an implementation, the third request message includes a first measurement setup identifier, and the first measurement setup identifier is an identifier of the sensing measurement setup requested by the third request message.

Step 1002: The first apparatus sends a third response message to the second apparatus.

Correspondingly, the second apparatus receives the third response message from the first apparatus.

The third response message is a message in response to the third request message. For example, the third response message may be a sensing measurement setup response frame or a DMG sensing measurement setup response frame.

In an implementation, the third response message indicates that the third request message is rejected, that is, the third response message indicates that the sensing measurement setup requested by the first apparatus is rejected. For example, if the second apparatus determines that sensing resources of the second apparatus have been used up as a sensing responder, for example, a number of sensing setups has reached a maximum number of supported setups as a sensing responder, the second apparatus may reject the third request message by using the third response message.

In an implementation, the third response message may include a status code, and the status code in the third response message may be REQUEST_DECLINED_NORESOURCE (REQUEST_DECLINED_NORESOURCE) or REJECTED_WITH_SUGGESTED_CHANGES_NORESOURCE (REJECTED_WITH_SUGGESTED_CHANGES_NORESOURCE). For a meaning of the status code, refer to the description of the status code in step 202. Details are not described herein.

Step 1003: The first apparatus sends a measurement setup query message to the second apparatus, where the measurement setup query message is used to request the second apparatus to set up a sensing measurement.

Correspondingly, the second apparatus receives the measurement setup query message from the first apparatus.

The first apparatus requests, by sending the measurement setup query message, the second apparatus to set up a symmetrical sensing measurement.

In an implementation, the measurement setup query message includes at least one of the following:
a measurement setup identifier field, where the measurement setup identifier field includes a first measurement setup identifier, that is, the measurement setup identifier field is used to carry a measurement setup identifier in a rejected sensing measurement setup request, and is used to be associated with the foregoing sensing measurement setup request; and
a fourth sensing measurement parameters element field, where the fourth sensing measurement parameters element field includes at least one sensing measurement parameter, and the sensing measurement parameter in the fourth sensing measurement parameters element field may be a sensing measurement parameter used by the second apparatus to initiate a symmetrical sensing measurement parameter.

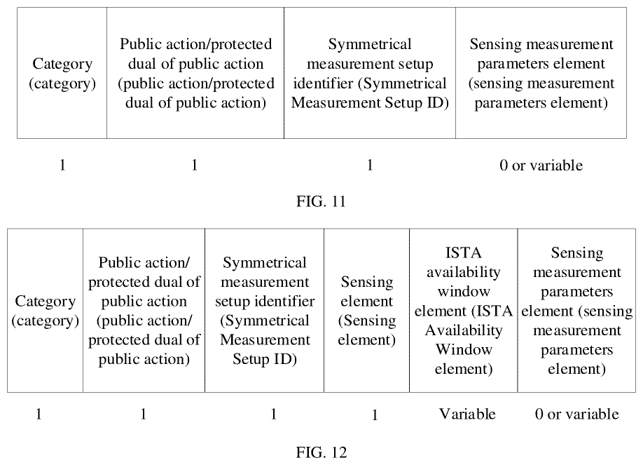

In this application, a specific structure of the measurement setup query message is not limited. In an implementation, FIG. 11 is an example diagram of a structure of a measurement setup query message according to an embodiment of this application. The measurement setup query message may include one or more of the following fields: a category, a public action/protected dual of public action, a symmetrical measurement setup identifier, and a sensing measurement parameters element. The symmetrical measurement setup identifier field may be the foregoing measurement setup identifier field, including the first measurement setup identifier; and the sensing measurement parameters element field may be the foregoing fourth sensing measurement parameters element field, including a sensing measurement parameter used by the second apparatus to initiate a symmetrical sensing measurement parameter.

In an implementation, FIG. 12 is an example diagram of a structure of a measurement setup query message according to an embodiment of this application. The measurement setup query message may include one or more of the following fields: a class, a public action/protected dual of public action, a symmetrical measurement setup identifier, a sensing element (Sensing element), an initiation station (Initiating STA, ISTA) availability window element (ISTA Availability Window element), and a sensing measurement parameters element. The measurement setup identifier field may be the foregoing measurement setup identifier field, including the first measurement setup identifier; and the sensing measurement parameters element field may be the foregoing fourth sensing measurement parameters element field.

Step 1004: The second apparatus sends a fourth request message to the first apparatus.

Correspondingly, the first apparatus receives the fourth request message from the second apparatus. In this case, the second apparatus may be a sensing initiator, and the first apparatus may be a sensing responder.

The fourth request message is used to request to set up a second sensing measurement. For example, the fourth request message may be a sensing measurement setup request frame in a sensing measurement setup process in wireless local area network sensing or a DMG sensing measurement setup request frame in a sensing measurement setup process in DMG sensing.

In an implementation, the fourth request message includes measurement indication information, and the measurement indication information indicates that the sensing measurement that the fourth request message requests to set up is associated with the first sensing measurement, or the measurement indication information indicates that the second sensing measurement that the fourth request message requests to set up is a sensing measurement symmetrical to the first sensing measurement.

In an implementation, the fourth request message includes a fifth sensing measurement parameters element field, and a sensing measurement parameter in the fifth sensing measurement parameters element field is determined based on the at least one sensing measurement parameter included in the fourth sensing measurement parameters element field. For example, the sensing measurement parameter in the fifth sensing measurement parameters element field may be completely or partially the same as the sensing measurement parameter in the fourth sensing measurement parameters element field.

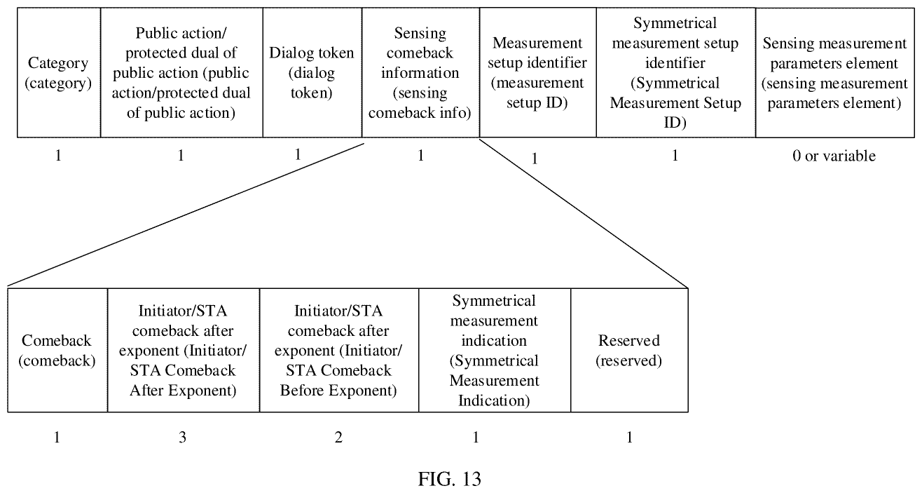

In this application, a specific structure of the fourth request message is not limited. In an implementation, when the fourth request message is the sensing measurement setup request frame, FIG. 13 is an example diagram of a structure of a sensing measurement setup request frame according to an embodiment of this application. The sensing measurement setup request frame may include one or more of the following fields: a category, a public action/protected dual of public action, a dialog token, sensing comeback information, a measurement setup identifier, a symmetrical measurement setup identifier, and a sensing measurement parameters element. The measurement setup identifier includes the second measurement setup identifier, the symmetrical measurement setup identifier includes the first measurement setup identifier, and the sensing measurement parameters element field may be the foregoing fifth sensing measurement parameters element field.

The sensing comeback information field may include a comeback subfield, an initiator/STA comeback after exponent subfield, an initiator/STA comeback before exponent subfield, a symmetrical measurement indication subfield, and a reserved subfield. The symmetrical measurement indication subfield is used to carry the measurement indication information. Specific meanings of the comeback subfield, the initiator/STA comeback after exponent subfield, the initiator/STA comeback before exponent subfield are not described. For details, refer to the foregoing descriptions, or refer to descriptions in the 802.11 series standards.

Optionally, step 1005: The first apparatus sends a fourth response message to the second apparatus.

Correspondingly, the second apparatus receives the fourth response message from the first apparatus.

The fourth response message is a message in response to the fourth message. Specific content of the fourth response message is not limited in this application, and details are not described herein.

According to the foregoing method, when the sensing measurement setup initiated by the first apparatus is rejected, the measurement setup query message may be separately sent, to indicate the second apparatus to initiate the sensing measurement setup as a sensing initiator when the second apparatus rejects the sensing measurement setup. In this way, when the second apparatus rejects the sensing measurement requested by the first apparatus, the second apparatus may initiate a symmetrical sensing measurement as a sensing initiator, to assist the first apparatus in completing the sensing measurement, thereby resolving a problem of how to implement a sensing measurement setup when resources of a sensing responder are full.

Currently, when an unassociated station (Unassociated STA, USTA) and an AP initiate a non-TB measurement procedure (in a non-TB measurement, the ASTA/USTA is a sensing initiator, and the AP is a sensing responder), after receiving a beacon (Beacon) frame of the AP, the USTA may determine, by using an extended capabilities element (extended capabilities element) field in the beacon frame, whether the AP has a sensing capability. On this basis, the USTA may request a capability of the AP by sending a probe request (Probe Request) frame to the AP, and the AP uses a probe response (Probe Response) frame to carry a sensing element (Sensing element) field, to declare a specific sensing capability of the AP.

After the USTA knows the sensing capability of the AP, if the USTA needs to initiate a non-TB sensing procedure, the USTA may send a sensing measurement setup request frame to the AP. After receiving the request frame, the AP replies to the USTA with a sensing measurement setup response frame to respond to the request of the USTA. When the AP replies to the USTA with the sensing measurement setup response frame, case 3 occurs.

Case 1: The status code in the sensing measurement setup response frame is SUCCESS: The AP agrees with a parameter in a sensing measurement setup request (carried in a sensing parameter element of the sensing measurement setup request frame) sent by the USTA, and receives the request.

Case 2: The status code in the sensing measurement setup response frame is REQUEST_DECLINED: The AP rejects a sensing request of the USTA.

Case 3: The status code in the sensing measurement setup response frame is REJECTED WITH SUGGESTED

_CHANGES: The AP cannot accept a parameter in a sensing measurement setup request, rejects the sensing measurement setup request of the USTA, but provides some suggested sensing measurement parameters for the USTA. In this case, the sensing measurement setup response frame sent by the AP to the USTA also carries a sensing parameters element field, which carries the sensing measurement parameters suggested by the AP for the USTA.

This application provides a method, so that before sending a sensing measurement setup request frame to an AP, a USTA exchanges sensing capability information of the USTA with the AP. If the AP sends a sensing measurement setup response frame to the USTA, and a status code in the sensing measurement setup response frame is REJECTED_WITH_SUGGESTED_CHANGES, the AP may know the sensing capability information of the USTA, so that a sensing measurement parameter carried in the sensing measurement setup response frame and suggested for the USTA better conforms to the sensing capability information of the USTA, thereby improving sensing measurement setup efficiency. Details are described below.

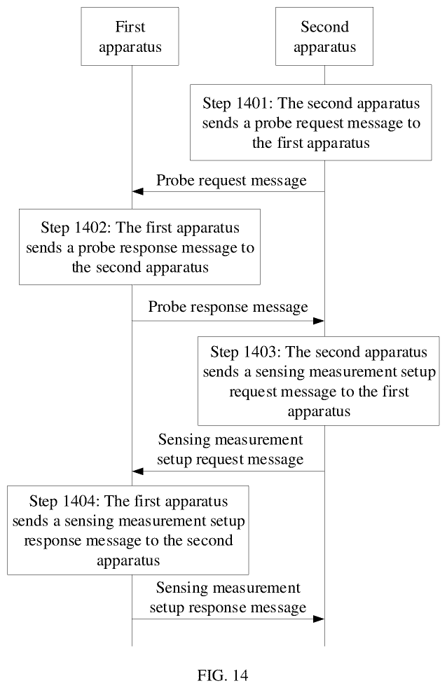

FIG. 14 is a schematic flowchart of a sensing method according to an embodiment of this application. When the method procedure provided in this embodiment of this application is applied to the system shown in FIG. 1, the STA or the chip in the STA in FIG. 1 may perform a method performed by a second apparatus in the following procedure, and the AP or the chip in the AP in FIG. 1 may perform a method performed by a first apparatus in the following procedure. It may be understood that a specific structure of an execution body of the method provided in this embodiment of this application is not specifically limited in the following embodiments, provided that a program that records code for the method provided in this embodiment of this application can be run to perform communication according to the method provided in this embodiment of this application. The method includes the following steps.

Step 1401: The second apparatus sends a probe request message to the first apparatus.

Correspondingly, the first apparatus receives the probe request message from the second apparatus. The probe request message may be used to request capability information of the first apparatus.

In an implementation, the first apparatus and the second apparatus in the procedure in FIG. 14 are not associated or are in an unassociated state. For example, the second apparatus is a USTA, and the first apparatus is an AP.

In an implementation, the probe request message further includes sensing capability information of the second apparatus. For example, the probe request message includes a sensing element (Sensing element), and the sensing capability information of the second apparatus may be located in the sensing element.

For another example, the probe request message includes at least one of a DMG sensing capabilities element (DMG Sensing Capabilities element) field and a DMG sensing short capabilities element (DMG Sensing Short Capabilities element) field, and the sensing capability information of the second apparatus may be located in the DMG sensing capabilities element and/or the DMG sensing short capabilities element.

Step 1402: The first apparatus sends a probe response message to the second apparatus.

Correspondingly, the second apparatus receives the probe response message from the first apparatus.

Step 1403: The second apparatus sends a sensing measurement setup request message to the first apparatus.

Correspondingly, the first apparatus receives the sensing measurement setup request message from the second apparatus.

In an implementation, the sensing measurement setup request message is used to request to set up a sensing measurement. For example, the sensing measurement setup request message may be a sensing measurement setup request frame or a DMG sensing measurement setup request frame.

In an implementation, the sensing measurement setup request message includes sensing capability information of the second apparatus. For example, the sensing measurement setup request message includes a sensing element, and the sensing capability information of the second apparatus may be located in the sensing element. For another example, the sensing measurement setup request message includes at least one of a DMG sensing capabilities element field and a DMG sensing short capabilities element field, and the sensing capability information of the second apparatus may be located in the DMG sensing capabilities element field and/or the DMG sensing short capabilities element field.

Step 1404: The first apparatus sends a sensing measurement setup response message to the second apparatus.

Correspondingly, the second apparatus receives the sensing measurement setup response message from the first apparatus.

The sensing measurement setup response message is a message in response to the sensing measurement setup request message. For example, the sensing measurement setup response message may be a sensing measurement setup response frame or a DMG sensing measurement setup response frame.

In an implementation, the first apparatus rejects the sensing measurement setup request message, that is, the first apparatus rejects the sensing measurement setup requested by the second apparatus. The sensing measurement setup response message may include a status code and a sensing measurement parameters element field. The status code indicates that a sensing measurement setup request is rejected and a suggested measurement parameter is provided. The sensing measurement parameters element field includes at least one sensing measurement parameter, the at least one sensing measurement parameter included in the sensing measurement parameters element field is determined based on the sensing capability information of the second apparatus, and the at least one sensing measurement parameter included in the sensing measurement parameters element field is a measurement parameter suggested by the first apparatus for the second apparatus.

In another implementation, when a status code included in the sensing measurement setup response message sent by the first apparatus is REJECTED_WITH_SUGGESTED_CHANGES, it may be agreed in advance that a sensing capability required by at least one sensing measurement parameter included in the sensing measurement setup response message is less than or equal to a sensing capability required by at least one sensing measurement parameter included in the sensing measurement setup request message. For example, if a sensing measurement parameter included in the sensing measurement setup request message sent by the second apparatus is a bandwidth of 80 MHz, a sensing measurement parameter included in the sensing measurement setup response message sent by the first apparatus may be a bandwidth less than or equal to 80 MHz. If a sensing measurement parameter included in the sensing measurement setup request message sent by the second apparatus is a minimum time interval between non-TB measurement instances, which is 10 μs, a sensing measurement parameter included in the sensing measurement setup response message sent by the first apparatus may be a suggested minimum time interval between non-TB measurement instances, which is greater than or equal to 10 μs. This avoids a case in which the sensing measurement parameter suggested by the first apparatus exceeds the sensing capability information of the second apparatus.

Currently, when a USTA expects to participate in a TB sensing process of an AP, the USTA first sends a sensing measurement setup query frame (Sensing Measurement Setup Query frame) to the AP. After receiving the query frame, the AP sends a sensing measurement setup request frame to the USTA. The request frame carries a sensing comeback information field, to indicate the USTA whether to re-initiate a sensing measurement setup query frame to the AP. If the AP cannot include the USTA in the measurement, the AP indicates, by using the sensing comeback information field in the sensing measurement setup request frame, the USTA to resend the sensing measurement setup query frame within a suggested time. In this application, a time at which the USTA resends the sensing measurement query frame is a time after a preset time reference point. For example, the preset time reference point in this scenario may be any one of the following:
a start moment or an end moment at which the USTA receives the sensing measurement setup request frame;
a start moment or an end moment at which the AP sends the sensing measurement setup request frame;
a start moment or an end moment at which the USTA sends the sensing measurement setup query frame; or
a start moment or an end moment at which the AP receives the sensing measurement setup query frame.

The foregoing method procedures in this application may be used in combination (for example, the method procedure in FIG. 2 and the method procedure in FIG. 7 are used in combination), or may be used separately. This is not limited in this application.

It should be noted that names of the messages and names of the fields in the foregoing procedures are merely examples. With evolution of communication technologies, the name of any one of the foregoing messages may change. However, regardless of how the names of the messages change, the messages fall within the protection scope of this application provided that meanings of the messages are the same as those of the foregoing messages in this application.

The foregoing procedures mainly describe the solutions provided in this application from a perspective of interaction between network elements. It may be understood that, to implement the foregoing functions, the foregoing network elements include corresponding hardware structures and/or software modules for performing the functions. A person skilled in the art should easily be aware that, in combination with units and algorithm steps of the examples described in embodiments disclosed in this specification, the present invention may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of the present invention.

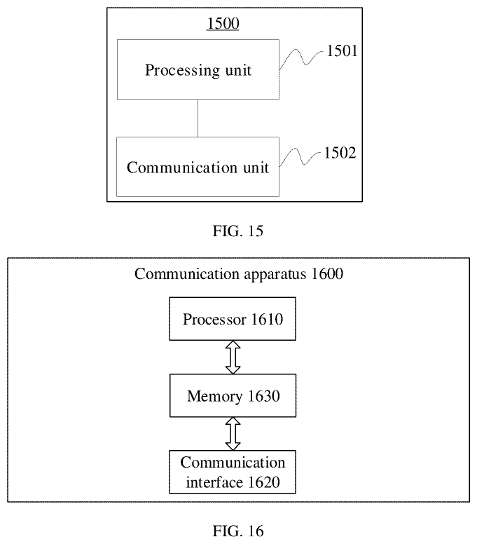

According to the foregoing methods, FIG. 15 is a diagram of a structure of a communication apparatus according to an embodiment of this application. The communication apparatus 1500 may be configured to implement a function of a first apparatus or a second apparatus (for example, an AP or a STA) in this embodiment of this application. For example, the communication apparatus may be a software module or a chip system. In this embodiment of this application, the chip system may include a chip, or may include a chip and another discrete component. The communication apparatus 1500 may include a processing unit 1501 and a communication unit 1502.

In this embodiment of this application, the communication unit may also be referred to as a transceiver unit, and may include a sending unit and/or a receiving unit, which are respectively configured to perform sending and receiving steps performed by the first apparatus or the second apparatus in the foregoing method embodiments. The processing unit may also be referred to as a processor, a processing board, a processing module, a processing apparatus, or the like. The sending unit sometimes may also be referred to as a transmitter machine, a transmitter, a transmit circuit, or the like. The receiving unit sometimes may also be referred to as a receiver machine, a receiver, a receive circuit, or the like. The sending unit and the receiving unit may be one unit integrated together, or may be two independent units.

It should be understood that descriptions of apparatus embodiments correspond to the descriptions of the method embodiments. Therefore, for content that is not described in detail, refer to the method embodiments. For brevity, details are not described herein.

In an implementation, the communication apparatus 1500 may perform the following functions.

The processing unit is configured to receive a first request message from the second apparatus through the communication unit, where the first request message is used to request to set up a sensing measurement.

The processing unit is configured to send a first response message to the second apparatus through the communication unit, where the first apparatus rejects the first request message, the first response message includes first indication information, and the first indication information indicates the second apparatus to resend a second request message for setting up a sensing measurement, or the first indication information indicates the second apparatus not to resend a second request message for setting up a sensing measurement.

In an implementation, the communication apparatus 1500 may perform the following functions.

The processing unit is configured to send a first request message to the first apparatus through the communication unit, where the first request message is used to request to set up a sensing measurement.

The processing unit is configured to receive a first response message from the first apparatus through the communication unit, where the first apparatus rejects the first request message, the first response message includes first indication information, and the first indication information indicates the second apparatus to resend a second request message for setting up a sensing measurement, or the first indication information indicates the second apparatus not to resend a second request message for setting up a sensing measurement.

In an implementation, the communication apparatus 1500 may perform the following functions.

The processing unit is configured to send a third request message to the second apparatus through the communication unit, where the third request message is used to request to set up a first sensing measurement, the third request message includes measurement request indication information, and the measurement request indication information indicates the second apparatus to set up a sensing measurement as a sensing initiator when the second apparatus cannot accept the first request message as a sensing responder.

The processing unit is configured to receive a third response message from the second apparatus through the communication unit, where the third response message indicates that the third request message is rejected.

In an implementation, the communication apparatus 1500 may perform the following functions.

The processing unit is configured to receive a third request message from the first apparatus through the communication unit, where the third request message is used to request to set up a first sensing measurement, the third request message includes measurement request indication information, and the measurement request indication information indicates the second apparatus to initiate a sensing measurement setup as a sensing initiator when the second apparatus cannot accept the first request message as a sensing responder.

The processing unit is configured to send a third response message to the first apparatus through the communication unit, where the third response message indicates that the third request message is rejected.

The foregoing is merely an example. The processing unit 1501 and the communication unit 1502 may further perform other functions. For more detailed descriptions, refer to the related descriptions in the foregoing method embodiments. Details are not described herein.

FIG. 16 shows a communication apparatus 1600 according to an embodiment of this application. The apparatus shown in FIG. 16 may be an implementation of a hardware circuit of the apparatus shown in FIG. 15. The communication apparatus is applicable to the flowchart shown above, and performs a function of the first apparatus or the second apparatus in the foregoing method embodiments. For ease of description, FIG. 16 shows only main components of the communication apparatus.

As shown in FIG. 16, the communication apparatus 1600 includes a processor 1610 and a communication interface 1620. The processor 1610 and the communication interface 1620 are coupled to each other. It may be understood that the communication interface 1620 may be a transceiver or an input/output interface. Optionally, the communication apparatus 1600 may further include a memory 1630, configured to: store instructions executed by the processor 1610, store input data required by the processor 1610 to run the instructions, or store data generated after the processor 1610 runs the instructions.

When the communication apparatus 1600 is configured to implement the method shown above, the processor 1610 is configured to implement a function of the processing unit 1501, and the communication interface 1620 is configured to implement a function of the communication unit 1502.

When the communication apparatus is a chip used in a terminal device, the chip of the terminal device implements the function of the terminal device in the foregoing method embodiments. The chip of the terminal device receives information from another module (for example, a radio frequency module or an antenna) in the terminal device; or the chip of the terminal device sends information to another module (for example, a radio frequency module or an antenna) in the terminal device.

It may be understood that the processor in embodiments of this application may be a central processing unit (Central Processing Unit, CPU), or may be another general-purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. The general-purpose processor may be a microprocessor or any conventional processor or the like.

The memory in embodiments of this application may be a random access memory (Random Access Memory, RAM), a flash memory, a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), a register, a hard disk drive, a removable hard disk, a CD-ROM, or any other form of storage medium well known in the art. For example, a storage medium is coupled to a processor, so that the processor can read information from the storage medium and write information into the storage medium. Certainly, the storage medium may be a component of the processor. The processor and the storage medium may be disposed in an ASIC.

The method steps in embodiments of this application may be implemented in a hardware manner, or may be implemented in a manner of executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an ASIC. In addition, the ASIC may be located in a base station or a terminal. Certainly, the processor and the storage medium may exist in the base station or the terminal as discrete components.

All or some of the foregoing embodiments may be implemented by using software, hardware, firmware, or any combination thereof. When software is used to implement the foregoing embodiments, all or a part of the foregoing embodiments may be implemented in a form of a computer program product. The computer program product includes one or more computer programs or instructions. When the computer programs or instructions are loaded and executed on a computer, all or some of the procedures or functions in embodiments of this application are performed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium accessible by the computer, or a data storage device, like a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or nonvolatile storage medium, or may include two types of storage media: a volatile storage medium and a nonvolatile storage medium.

A person skilled in the art should understand that the embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

1. A first apparatus, comprising:
at least one processor; and
a memory, storing instructions, which when executed by the at least one processor, cause the first apparatus to:
receive a first request message from a second apparatus, wherein the first request message is used to request to set up a sensing measurement;
reject the first request message; and
send a first response message to the second apparatus, wherein the first response message comprises first indication information, and the first indication information indicates the second apparatus whether to resend a second request message for setting up a sensing measurement.

2. The first apparatus according to claim 1, wherein a sending time of the second request message is greater than or equal to a first time, and is less than or equal to a second time.

3. The first apparatus according to claim 2, wherein the first response message further comprises at least one of second indication information and third indication information; and
the second indication information indicates the first time, and the third indication information indicates the second time.

4. The first apparatus according to claim 1, wherein the first request message further comprises a first sensing measurement parameters element field, the first sensing measurement parameters element field comprises at least one sensing measurement parameter, the second request message comprises a second sensing measurement parameters element field, and the first response message further comprises a status code; and
if the status code indicates that a sensing measurement setup request is rejected, and the first indication information indicates the second apparatus to resend the second request message for setting up a sensing measurement, a sensing measurement parameter in the second sensing measurement parameters element field is determined based on the at least one sensing measurement parameter in the first sensing measurement parameters element field.

5. The first apparatus according to claim 1, wherein the second request message comprises a second sensing measurement parameters element field, the first response message further comprises a third sensing measurement parameters element field and a status code, and the third sensing measurement parameters element field comprises at least one sensing measurement parameter; and
if the status code indicates that a sensing measurement setup request is rejected and a suggested measurement parameter is provided, and the first indication information indicates the second apparatus to resend the second request message for setting up a sensing measurement, a sensing measurement parameter in the second sensing measurement parameters element field is determined based on the at least one sensing measurement parameter in the third sensing measurement parameters element field.

6. The first apparatus according to claim 1, wherein the first response message further comprises the status code; and
the status code indicates that the sensing measurement setup request is rejected, and a rejection cause is that resources for the first apparatus to set up a sensing measurement as a sensing responder are full; or
the status code indicates that the sensing measurement setup request is rejected, and a rejection cause is that the first apparatus or a sensing link is interfered with.

7. The first apparatus according to claim 1, wherein the first apparatus is a sensing responder, and the second apparatus is a sensing initiator.

8. The first apparatus according to claim 1, wherein
the first request message is a sensing measurement setup request frame in a sensing measurement setup process in wireless local area network sensing; or
the first request message is a directional multi-gigabit sensing measurement setup request frame in a sensing measurement setup process in directional multi-gigabit sensing.

9. The first apparatus according to claim 1, wherein the instructions, which when executed by the at least one processor, further cause the first apparatus to:
receive a probe request message from the second apparatus before receiving the first request message, wherein the probe request message comprises sensing capability information of the second apparatus.

10. The first apparatus according to claim 9, wherein the first response message further comprises the third sensing measurement parameters element field and the status code; and
if the status code indicates that the sensing measurement setup request is rejected and the suggested measurement parameter is provided, and the first indication information indicates the second apparatus to resend the second request message for setting up a sensing measurement, the sensing measurement parameter in the third sensing measurement parameters element field is determined based on the sensing capability information of the second apparatus.

11. A second apparatus, comprising:
at least one processor; and
a memory, storing instructions, which when executed by the at least one processor, cause the first apparatus to:
send a first request message to a first apparatus, wherein the first request message is used to request to set up a sensing measurement; and
receiving a first response message from the first apparatus in response to the first request message is rejected, the first response message comprises first indication information, and the first indication information indicates the second apparatus whether to resend a second request message for setting up a sensing measurement.

12. The second apparatus according to claim 11, wherein a sending time of the second request message is greater than or equal to a first time, and is less than or equal to a second time.

13. The second apparatus according to claim 12, wherein the first response message further comprises at least one of second indication information and third indication information; and
the second indication information indicates the first time, and the third indication information indicates the second time.

14. The second apparatus according to claim 11, wherein the first request message further comprises a first sensing measurement parameters element field, the first sensing measurement parameters element field comprises at least one sensing measurement parameter, the second request message comprises a second sensing measurement parameters element field, and the first response message further comprises a status code; and
if the status code indicates that a sensing measurement setup request is rejected, and the first indication information indicates the second apparatus to resend the second request message for setting up a sensing measurement, a sensing measurement parameter in the second sensing measurement parameters element field is determined based on the at least one sensing measurement parameter in the first sensing measurement parameters element field.

15. The second apparatus according to claim 11, wherein the second request message comprises a second sensing measurement parameters element field, the first response message further comprises a third sensing measurement parameters element field and a status code, and the third sensing measurement parameters element field comprises at least one sensing measurement parameter; and
if the status code indicates that a sensing measurement setup request is rejected and a suggested measurement parameter is provided, and the first indication information indicates the second apparatus to resend the second request message for setting up a sensing measurement, a sensing measurement parameter in the second sensing measurement parameters element field is determined based on the at least one sensing measurement parameter in the third sensing measurement parameters element field.

16. The second apparatus according to claim 11, wherein the first response message further comprises a status code; and
if the status code indicates that a sensing measurement setup request is rejected and a suggested measurement parameter is provided, and the first indication information indicates the second apparatus not to resend the second request message for setting up a sensing measurement, a time for the second apparatus to re-initiate a sensing measurement setup is after a third time.

17. The second apparatus according to claim 11, wherein the first response message further comprises the status code; and
the status code indicates that the sensing measurement setup request is rejected, and a rejection cause is that resources for the first apparatus to set up a sensing measurement as a sensing responder are full; or
the status code indicates that the sensing measurement setup request is rejected, and a rejection cause is that the first apparatus or a sensing link is interfered with.

18. The second apparatus according to claim 11, wherein the first apparatus is a sensing responder, and the second apparatus is a sensing initiator.

19. The second apparatus according to claim 11, wherein
the first request message is a sensing measurement setup request frame in a sensing measurement setup process in wireless local area network sensing; or
the first request message is a directional multi-gigabit sensing measurement setup request frame in a sensing measurement setup process in directional multi-gigabit sensing.

20. The second apparatus according to claim 11, wherein the instructions, which when executed by the at least one processor, further cause the second apparatus to:
send a probe request message to the first apparatus before sending the first request message, wherein the probe request message comprises sensing capability information of the second apparatus.
